(19) United States
(12) Patent Application Publication
(10) Pub. No.: US 2016/0257399 A1
(43) Pub. Date: Sep. 8, 2016

(54) MAST DAMPENER AND COLLECTIVE PITCH FOR A ROTORCRAFT

(71) Applicant: Carter Aviation Technologies, LLC, Wichita Falls, TX (US)

(72) Inventors: Jay W. Carter, JR., Burkburnett, TX (US); Jeffrey R. Lewis, Wichita Falls, TX (US); M. Keith Robinson, Wichita Falls, TX (US)

(21) Appl. No.: 14/645,348

(22) Filed: Mar. 11, 2015

Related U.S. Application Data
(60) Provisional application No. 61/951,035, filed on Mar. 11, 2014.
(60) Provisional application No. 61/951,064, filed on Mar. 11, 2014.
(60) Provisional application No. 61/951,083, filed on Mar. 11, 2014.
(60) Provisional application No. 61/951,118, filed on Mar. 11, 2014.

(51) Int. Cl. B64C 27/72; B64C 27/59; B64C 27/57; B64C 27/02

(52) U.S. Cl. CPC B64C 27/72; B64C 27/025; B64C 27/59; B64C 27/57

(57) ABSTRACT

An embodiment includes a system for controlling blade pitch in a rotorcraft having an engine; a drive shaft with a first end and a second end and connected at the first end to the engine; a rotor with two or more blades connected to the second end of the drive shaft; and one or more actuators positioned adjacent to the rotor blades operable to change a blade pitch of the rotor blades.

### CROSS-REFERENCE TO RELATED APPLICATIONS

This application claims priority to U.S. Provisional Patent Application No. 61/951,035 filed on Mar. 11, 2014, which is incorporated herein by reference in its entirety. This application also claims priority to U.S. Provisional Patent Application No. 61/951,064 filed on Mar. 11, 2014, which is incorporated herein by reference in its entirety. This application further claims priority to U.S. Provisional Patent Application No. 61/951,083 filed on Mar. 11, 2014, which is incorporated herein by reference in its entirety. This application also claims priority to U.S. Provisional Patent Application No. 61/951,118 filed on Mar. 11, 2014, which is incorporated herein by reference in its entirety.

### TECHNICAL FIELD

This disclosure relates rotor aircrafts in general, and more particularly, mast dampeners and collective pitch in a rotorcraft.

### BACKGROUND

Rotorcrafts consist of an airframe attached to a rotor and include, for example, helicopters, gyrocopters and compound and slowed-rotor compound aircrafts such as gyroplanes and heliplanes. The rotor is essentially a large rotating mass that includes two or more rotor blades. Rotorcrafts can generally take-off and land vertically and the rotor, during at least a portion of the flight, provides all or substantially all of the lift.

In some instances, the rotor, being a large rotating mass, is prone to creating resonance. Resonance may be described as the tendency of a system to oscillate with greater amplitude when some driving force closely matches the natural frequency of the system. In some instances, the resonance can cause the amplitude of oscillation to become so great that the system fails catastrophically. Current methods to address resonance on rotorcraft typically include damping vibration isolators.

Additionally, rotorcrafts incorporate rotor blade pitch control that acts to control the lift produced by the rotor. The control of blade pitch is an essential element for the control of conventional helicopters; for gyroplanes, it is necessary to be able to perform jump takeoffs and also provides finer control during landing.

### SUMMARY

In a first embodiment, a system for controlling blade pitch in a rotorcraft includes an engine; a drive shaft having a first end and a second end and connected at the first end to the engine; a rotor having two or more blades connected to the second end of the drive shaft; and one or more actuators positioned adjacent to the rotor blades operable to change a blade pitch of the rotor blades.

In some aspects, the system further comprises a control box operable to send command signals to the one or more actuators.

In some aspects, the system further comprises a first control box connected to a collective lever and a second control box, in communication with the first control box, connected to the one or more actuators.

In some aspects of the system, a first actuator is connected to a first rotor blade and a second actuator is connected to a second rotor blade.

In some aspects of the system, the one or more actuators are affixed to the rotor blades.

In some aspects of the system, the one or more actuators are affixed to a flexible beam.

In some aspects, the system further comprises a bell crank attached to the one of the one or more actuators; and a pitch linkage having a first end attached to the bell crank and a second end attached a blade skin, the blade skin being a portion of a blade; wherein the actuator moves the bell crank causing the pitch linkage to move, thereby causing the blade skin to rotate about a bearing, changing the blade pitch of the blade.

In some aspects, the system further comprises a first actuator attached to a portion of a spar located in a first blade, the spar covered by a first blade skin, and a first pitch linkage assembly connected to a first actuator, a first cross link and the first blade skin; a second actuator attached to a portion of the spar located in a second blade, the spar covered by a second blade skin, and a second pitch linkage assembly connected to a second actuator, a second cross link and the second blade skin; and a cross lever connected to the first and second cross links.

In some aspects, the system further comprises a slip ring positioned adjacent the first end of the drive shaft.

In some aspects, the system further comprises a first control box positioned proximate the first end of the drive shaft and a second control box positioned proximate the second end of the drive shaft, the first control box connected to the second control box via connectors.

In some aspects, the system further comprises a slip ring positioned proximate the first end of the drive shaft for feeding connectors to the second control box to prevent the connectors from becoming tangled as the drift shaft rotates.

In a second embodiment, a system for adjusting a blade pitch in a rotorcraft, comprises a rotor having two or more blades; and one or more actuators operably connected to at least one of the blades to change a blade pitch.

In some aspects, the system further comprises a collective lever arm operable to move, the movement operable to cause the blades to change their respective blade pitch; a collective lever arm sensor attached to the collective lever arm to sense a position of the collective lever arm; a collective lever arm actuator attached to the collective lever arm operable to automatically move the collective lever arm; a first control box connected to the collective lever arm sensor to receive data from the collective lever arm sensor and connected to the collective lever arm actuator operable to send command signals to the collective lever arm actuator causing the collective lever arm actuator to move the collective lever arm; a second control box connected to the first control box via connectors to provide communication between the first and second control boxes, the connectors positioned through a slip ring, the second control box connected to the one or more actuators operable to send command signals and power to the one or more actuators and receive data from the one or more actuators; and a pitch sensor positioned adjacent a pitch linkage, the pitch sensor in communication with the second control box for sending pitch angle data to the second control box.

In some aspects, the system further comprises an engine; and a drive shaft having a first end and a second end and connected at the first end to the engine; wherein the rotor is connected to the second end of the drive shaft.

In a third embodiment, a method for controlling blade pitch in a rotorcraft, comprises receiving data input from one or more sensors; and sending a command to an actuator positioned in the rotor and operably connected to a pitch linkage to move the pitch linage thereby changing a pitch angle of a rotor blade.

In some aspects of the method, the step of receiving the data input from the one or more sensors is responsive to changing the pitch angle of the rotor blade.

In some aspects of the method, the data input relates to pitch angle.

In some aspects of the method, wherein the step of sending the command to the actuator is responsive to receiving the data input from the one or more sensors.

In some aspects of the method, wherein the data input relates to a position of a collective pull lever.

In some aspects, the method further comprises collectively changing the pitch angle of all rotor blades attached to the rotorcraft.

In a fourth embodiment, a method for adjusting blade pitch of a blade in a rotorcraft includes the steps of moving a collective lever; sending position data to a control box indicating a position of the collective lever; and sending a predetermined amount of power to an actuator positioned in a rotor head based on the data sent to the control box causing the actuator to move a pitch linkage attached to the blade a correspondingly predetermined distance, thereby changing the blade pitch of the blade.

In one aspect, the method further includes sending blade pitch data to the control box indicating the a pitch angle of the blade; commanding, the command sent from the control box, an actuator attached to the collective lever to move the collective lever thereby causing the pitch angle of the blade to change; and responsive to moving the collective lever, sending new blade pitch data to the control box indicating a new pitch angle of the blade.

### DESCRIPTION OF THE FIGURES

The accompanying drawings facilitate an understanding of the various embodiments.

FIG. 1 is a perspective view of a gyroplane constructed in accordance with this description.

FIG. 2 is a schematic sectional illustration of the blades of the gyroplane of FIG. 1, one of the blades being shown in solid lines and the other blade shown in dotted lines, and the blades being illustrated at a positive collective pitch.

FIG. 3 is a schematic view as seen from above of the aircraft of FIG. 1, and illustrating a Mu greater than 1.0.

FIG. 4 is a schematic view as seen from one side of the rotor of the aircraft of FIG. 1, with the aircraft not being shown.

FIG. 5 is a schematic view of the tilt mechanism and the controller of the aircraft of FIG. 1.

FIG. 6 is a schematic view of the collective mechanism.

FIG. 7 is a graph of Pitch vs. Mu.

FIG. 8 is a notional graph showing the relationship between airspeed and rotor blade pitch, rotor RPM and Mu when the pitch is controlled vs. Mu.

FIG. 9 is a partial perspective view illustrating components of the collective pitch assembly of the aircraft of FIG. 1.

FIG. 10 is a schematic view of an automatic pitch controller for the collective pitch assembly shown in FIG. 9.

FIG. 11 is a notional graph showing the relationship between airspeed and rotor blade pitch, rotor RPM and Mu when the pitch is controlled vs. RPM.

FIG. 12 is a notional graph showing the relationship between airspeed and rotor blade pitch, rotor RPM and Mu when the pitch is controlled vs. RPM.

FIG. 13 is a perspective view of with a portion cut-away of a rotor blade.

FIG. 14 is a detailed partial view of FIG. 13.

FIG. 15 is a top partial view of FIG. 13

FIG. 16 is a partial cross-sectional view of FIG. 15 taken along lines A-A.

FIG. 17 is a schematic view of a collective pitch assembly.

FIG. 18 is a perspective view of a gyroplane constructed in accordance with this description with a portion cut-away.

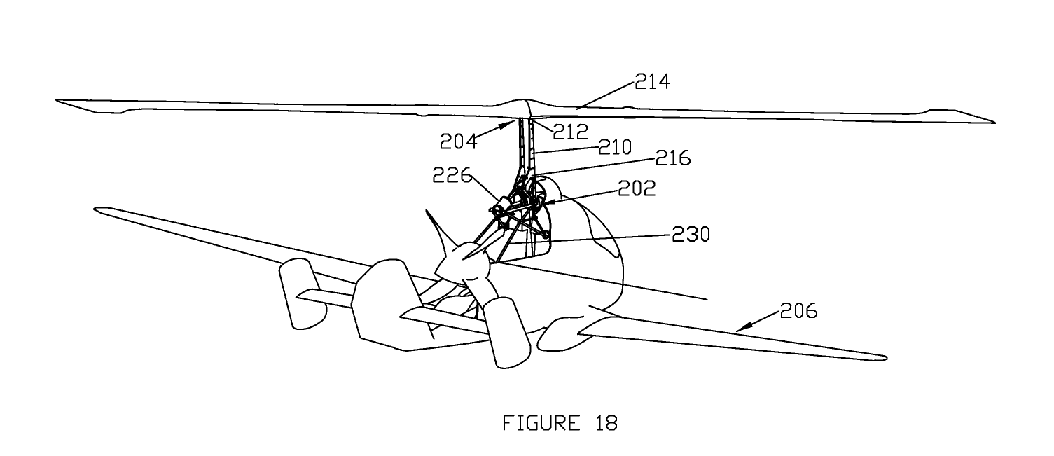

FIG. 19 is a side view of a mast-airframe connection assembly.

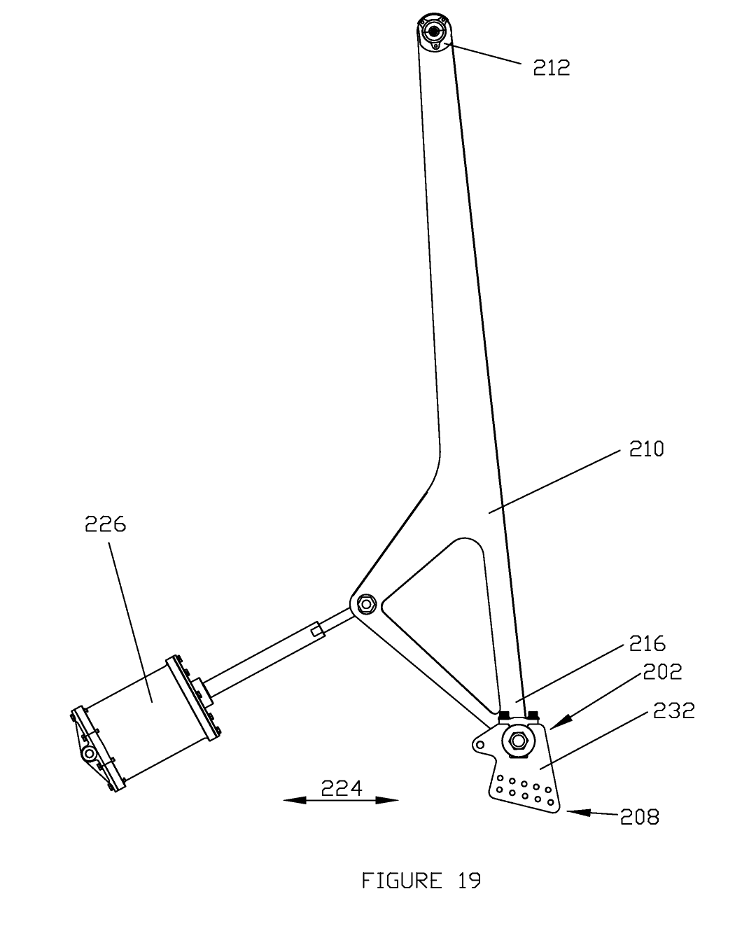

FIG. 20 is a detailed, side view of a mast-airframe connection assembly.

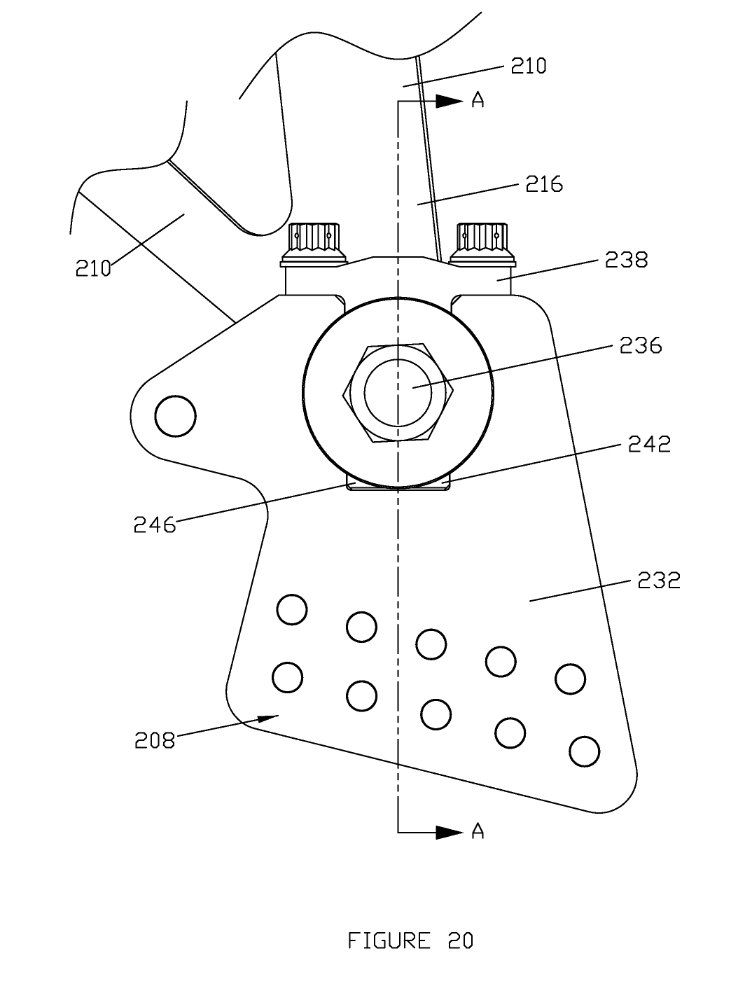

FIG. 21 is a cross-sectional view of FIG. 20 taken along lines A-A.

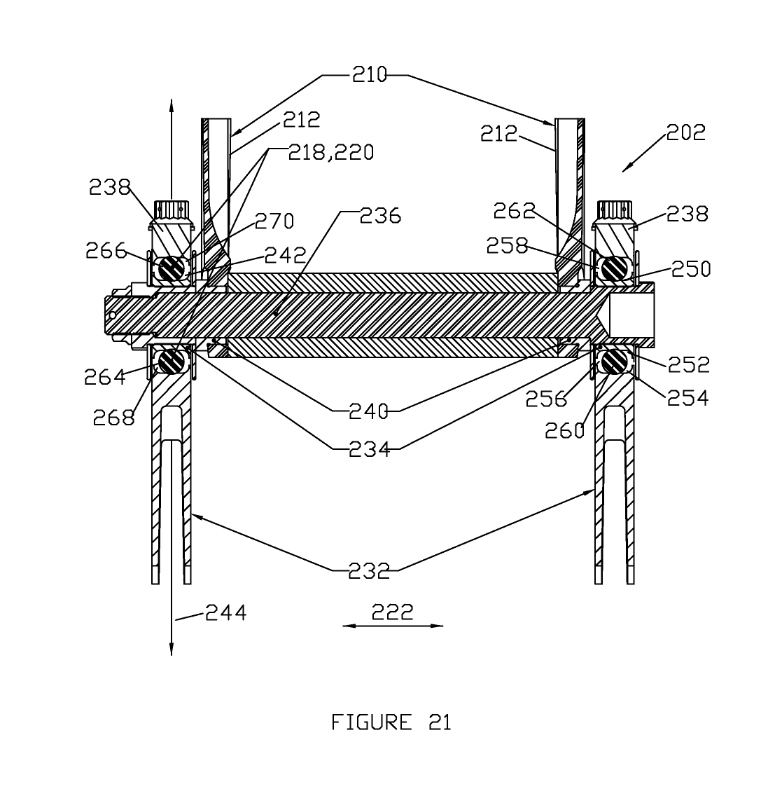

FIG. 22 is an exploded view of a mast-airframe connection assembly.

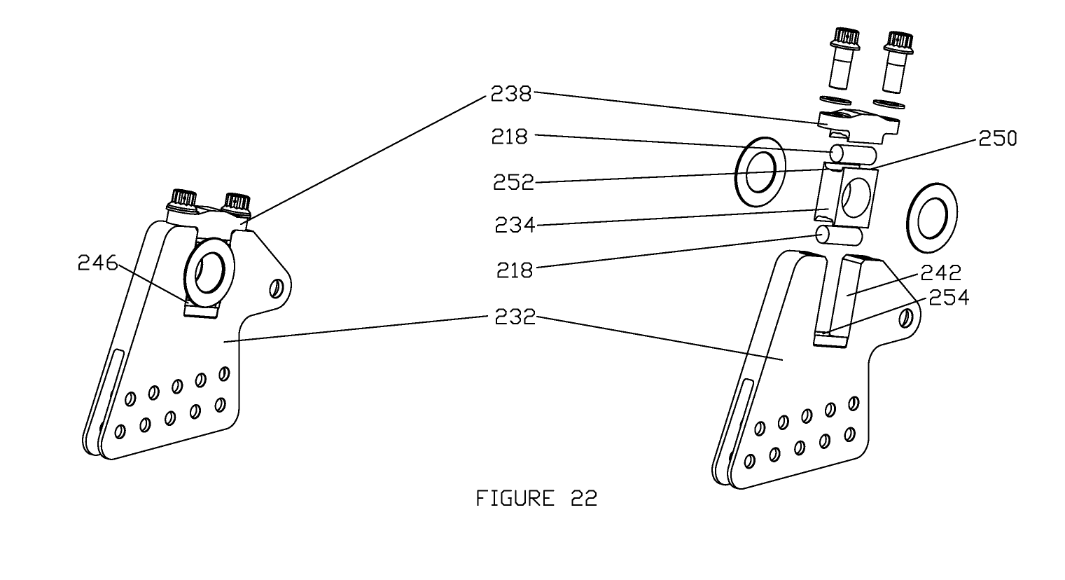

### DETAILED DESCRIPTION

It should be appreciated that the terms aircraft, rotorcraft, gyrocopter, gyroplane, helicopter, heliplane, and other similar terms are used generally to refer to rotor aircrafts and may be used interchangeably to describe all rotor aircrafts unless specified otherwise.

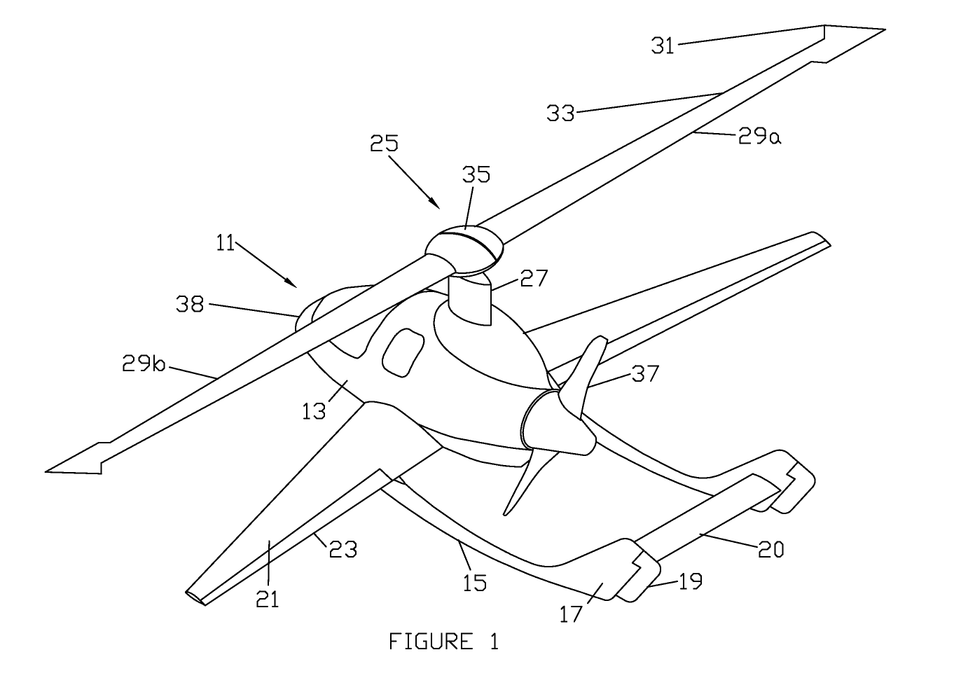

Referring to FIG. 1, aircraft 11 is gyroplane having a fuselage 13 with tail booms 15 in this example. A vertical stabilizer 17 is located at the end of each tail boom 15. A rudder 19 is mounted to the aft end of each stabilizer 17. A movable elevator 20 extends between tail booms 15 at vertical stabilizers 17.

Fuselage 13 has a pair of wings 21 that provide lift during forward flight. Each wing 21 has an aileron 23 in this embodiment. A rotor 25 is mounted above fuselage 13 on a mast 27. Rotor 25 is shown with two blades 29, but it could have more than two. During each revolution, one blade 29a becomes the advancing blade while the other blade 29b becomes the retreating blade. Blades 29 have tip weights 31 at their tips for providing inertia during take-off and stiffness during slow rotation at cruise speeds. Preferably tip weights 31 are forward of the leading edge 33 of each blade 29. Blades 29 join each other at a hub 35 at the upper end of mast 27. Preferably hub 35 is split into two halves movable relative to each other, with the shell of each blade 29 being integrally joined to one of the halves of hub 35.

Aircraft 11 has an engine (not shown) that powers rotor 25 for pre-rotation prior to takeoff. The engine also powers a propeller 37, which is shown as a pusher propeller but could also be a tractor type. Alternately, forward propulsion and rotation of rotor 25 could be provided by a jet engine. Aircraft 11 has a true airspeed sensor 38.

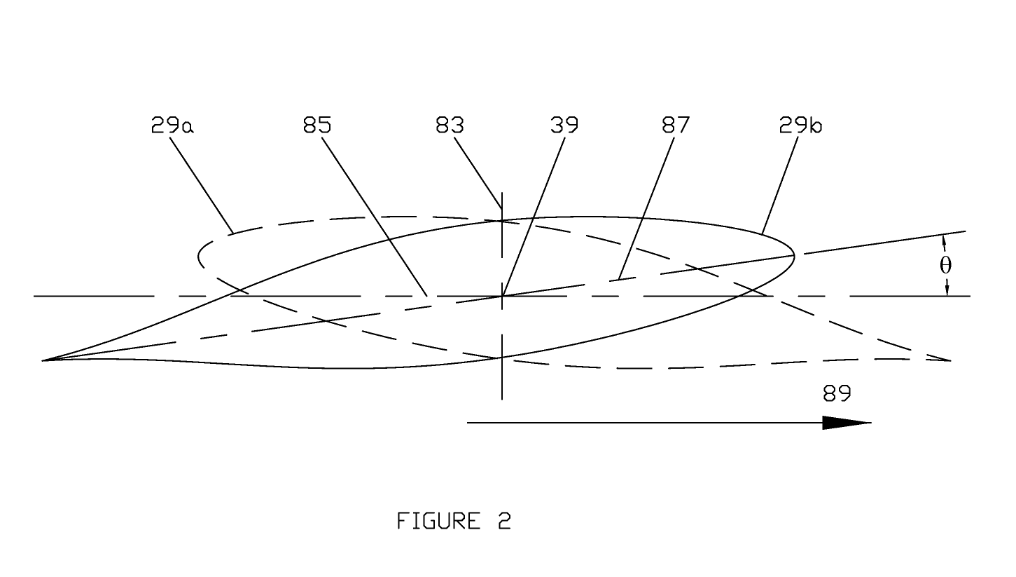

Referring to FIG. 2, blades 29 are movable relative to each other about a pitch axis 39 to vary the collective pitch. In the position shown in FIG. 2, each leading edge 33 of each blade 29 tilts upward or twists about pitch axis 39 to increase the collective pitch. An increase in collective pitch increases the angle of attack. If rotated or twisted about pitch axis 39 in the opposite direction, leading edge 33 will move downward to the plane of rotation. Rotor 25 produces greater lift when the pitch is at a high level, as shown in FIG. 2, than when the collective pitch is at a lesser level or zero. FIG. 2 further illustrates an axis of rotation 83, a plane of rotation 85, a chord line 85 and a direction of rotation 89.

Aircraft 11 (FIG. 1) is designed so that at short or vertical takeoffs and landings and slow speed flight, rotor 25 will produce a substantial part of the lift, but at cruise flight, rotor 25 will produce very little of the lift, rather the lift will be provided by wings 21. Collective pitch is thus adjusted from the high positive level shown in FIG. 2 to between 1.5 and minus 0.5 degrees at high speed cruise speeds (advance ratio >about 0.7).

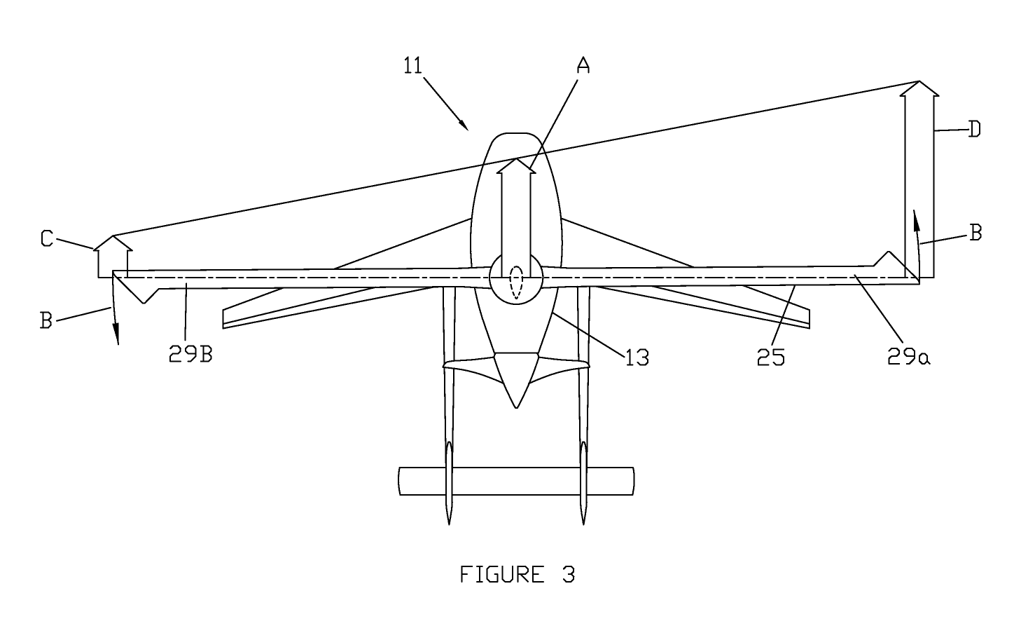

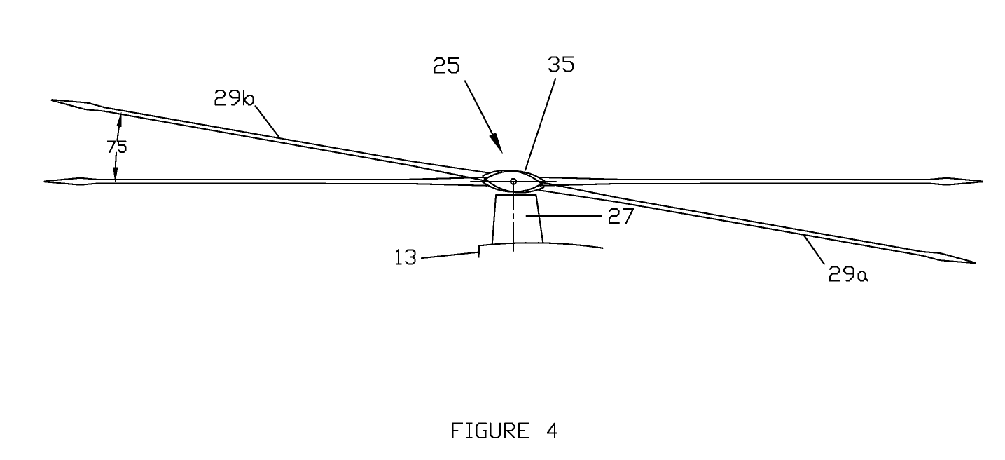

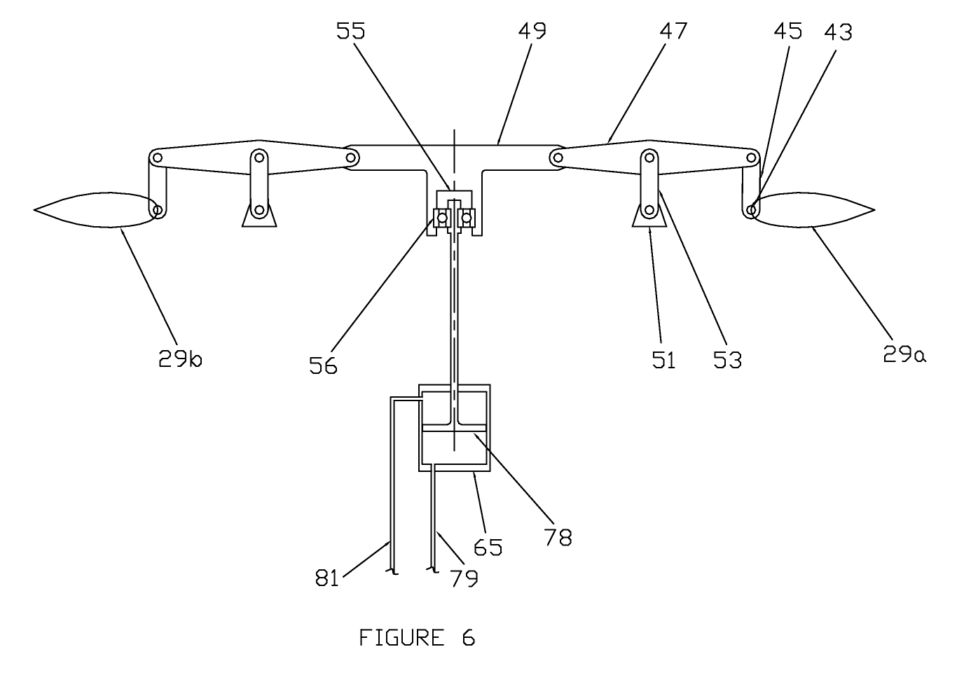

As discussed in the background of the invention above and schematically illustrated in FIGS. 3 and 4, flapping is a means by which the advancing and retreating blades 29a, 29b can achieve lift moment equilibrium, and is in general a function of Mu and lift. Mu is defined as the forward speed of the aircraft divided by the rotational tip speed of the rotor relative to the aircraft. Lift, with a resulting upward force, can be greatly altered by rotor pitch. For a given Mu, there is a range of blade pitches that will allow the rotor to auto-rotate while still providing the lift required without excessive flapping. These collective pitches can be calculated as well as determined empirically by test flights. FIG. 6 illustrates schematically the flapping angle 75.

FIG. 3 illustrates aircraft 11 when flying at a Mu greater than 1. Rotor 25 is auto-rotating at a low rate of speed due to a shallow angle of attack relative to the air stream. Rotor 25 is rotating only at a high enough speed to produce enough centrifugal force to keep blades 29 stiff and stable, corresponding to a rotor tip speed between 150 and 250 ft/sec. The rotational speed is typically less than one-third the rotational speed employed at jump take-off, which may be at an RPM corresponding to a rotor tip speed of Mach 0.8 or more. At the slow tip speeds, with the rotor only producing a small percentage of lift, both the advancing blade 29a and retreating blade 29b can produce the same lift moments without stalling. At a Mu greater than 1.0, the entire air flow over retreating blade 29b is in reverse due to the high aircraft speed A and the slow speed of rotation. The rotational speed of rotor 25 results in a linear component B at the tip of each blade 29. The advancing blade will have a tip velocity D, which is the sum of aircraft velocity A and the rotational velocity component B. The velocity C of retreating blade 29b is equal to the aircraft velocity A less the rotational velocity component B. As a result, the entire flow over the retreating blade 29b is from the trailing edge to the leading edge when Mu is greater than 1.0.

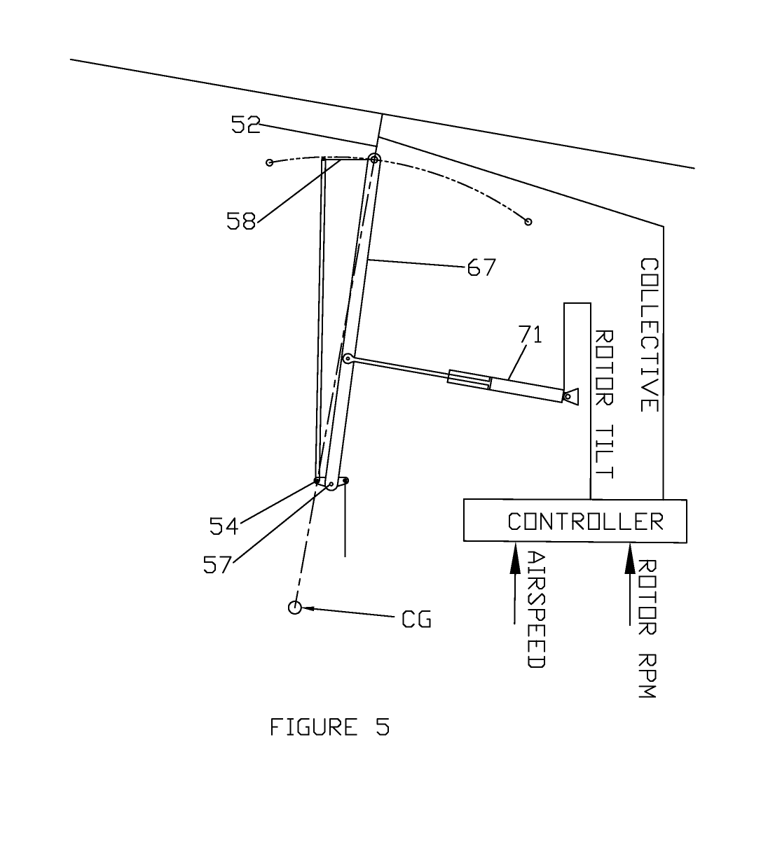

FIG. 5 illustrates the components of the tilting mast 67. The mast pivot axis 57 is generally located above and aft of the aircraft CG (center of gravity). A lever arm 54 is pivotally mounted to mast 67 for cyclic pitch control, which refers to tilting the rotor plane of rotation relative to mast 67 in fore and aft and lateral directions. In this example, the rotor plane of rotation is tilted relative to mast 67 by a tilting spindle, which has an axis 52 spaced from a spindle arm 58 and is connected to lever arm 54. Mast 67 can be tilted as much as 25 degrees, but only in fore and aft directions. When mast 67 is tilted, spindle axis 52 and the rotor center of lift relative to the aircraft center of gravity (CG) remain essentially constant. This arrangement basically keeps the aircraft pitch from changing as mast 67 is tilted fore and aft. This arrangement also allows the rotor cyclic pitch relative to the airstream to change, which can control the rotor RPM once the rotor is unloaded and the rotor RPM has dropped to its minimum level. Mast 67 is driven in the fore and aft direction with a cylinder 71, which is mounted to fuselage 13 (FIG. 1).

FIG. 6 illustrates the components of one embodiment of the collective pitch assembly. Each blade is integrally joined to one of the hub half portions 35 (FIG. 1). A pitch horn 43 is secured to each blade 29. Each pitch horn 43 can be located either forward or aft of pitch axis 39. When moved up and down, each pitch horn 43 will rotate blade 29 about a twistable I beam type spar (not shown) and about pitch axis 39.

Each pitch horn 43 is pivotally connected to a push rod 45, which in turn is connected to a collective arm 47. Collective arm 47 is pivotally mounted to a collective tee 49. Collective tee 49 is able to reciprocate up and down relative to spindle (not shown). Links 53 are mounted to the spindle (not shown) at a point along each collective arm 47. When collective tee 49 moves downward, links 53 serve as fulcrums to cause push rods 45 and pitch horns 43 to move upward in unison. Similarly, when collective tee 49 moves upward relative to the spindle, pitch horns 43 move downward in unison.

The spindle is mounted to a rotatably driven shaft (not shown) through which extends an upper collective shaft 55. Collective tee 49 is mounted to the upper end of upper collective shaft 55 for upward and downward movement therewith. The spindle and cyclic pitch control mechanism is not shown, however it tilts the rotor in the fore and aft and lateral directions. A hydraulic cylinder 65 is located below the spindle and is non-rotating, but transfers its up and down movement through a thrust bearing 56.

In this embodiment, an automatic controller (FIG. 5), which is a computer, controls the collective pitch. Also, the controller will control fore and aft tilt of rotor 25 automatically to hold the minimum desired rotor RPM. A true air speed sensor 38 (FIG. 1) provides an input to the controller. A conventional rotor RPM sensor or tachometer also provides an input signal to the controller. The controller is programmed to provide outputs to collective pitch control hydraulic cylinder 65 and mast tilt cylinder 71.

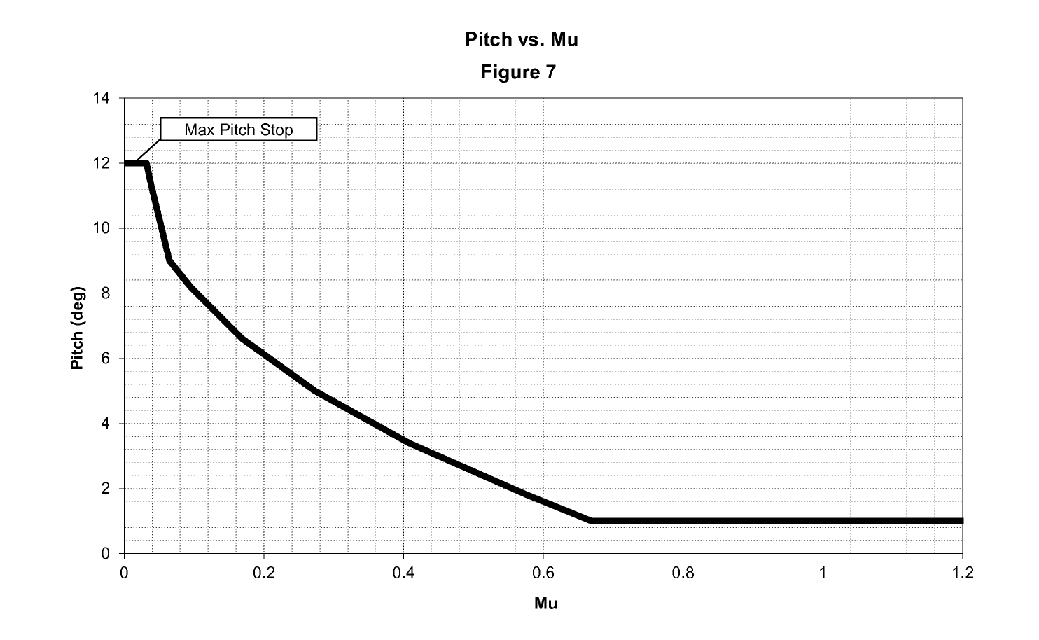

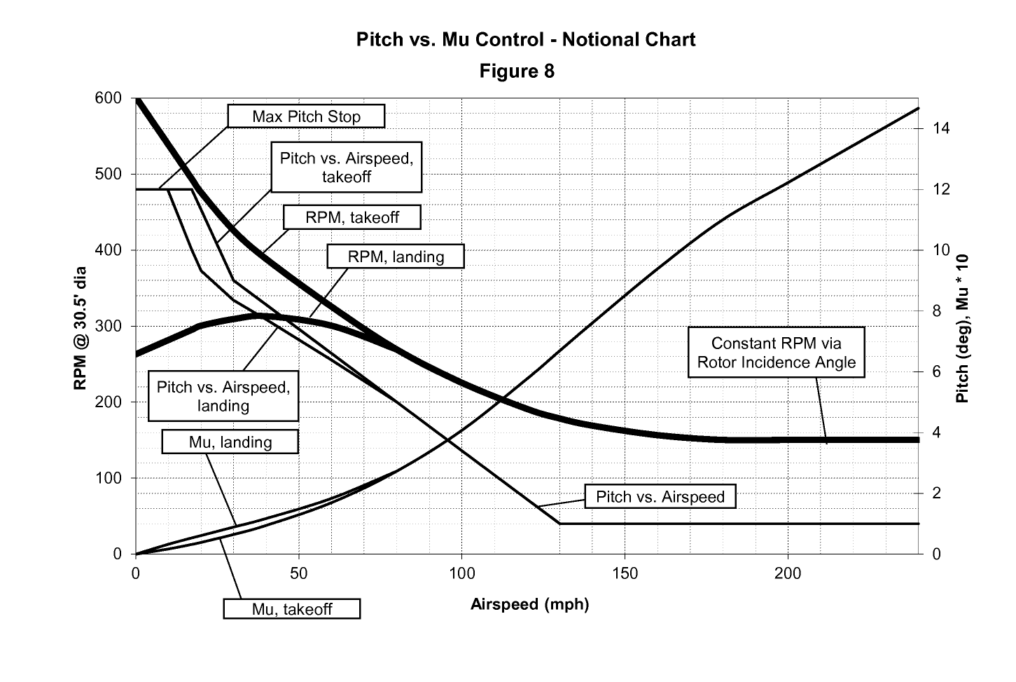

In general, the controller varies the blade collective pitch as a function of Mu, such that at some Mu associated with a minimum straight and level forward speed such as 30 mph, Mu equals the highest blade pitch that will allow auto-rotation, such as 9 degrees. At a Mu greater than a selected amount, such as 0.75, the collective pitch will be low, such as 1.5 degrees positive to about minus 0.5 degree. Varying the collective blade pitch in accordance with this function will restrain blade flapping within a desired amount, such as approximately 1 to 4 degrees. FIG. 7 illustrates an example of a curve or relationship between collective pitch and Mu that if utilized, will maintain flapping within the desired amount. Although termed “curve”, the curve of FIG. 7 could be straight or curved. FIG. 8 shows the relationship between Mu and pitch in a different and more detailed manner, with the right side of the graph being both collective pitch and Mu. The units on the right side refer to degrees or to ten times Mu. For example, the unit 4 would be 0.4 Mu.

In operation, referring to FIGS. 7 and 8, prior to pre-rotating rotor 25, the pilot preferably selects a take-off collective pitch for the controller to employ once the rotor clutch (not shown) is disengaged and the pilot is ready to take off. During a jump takeoff, the pilot rotates rotor 25 at near 0 degree collective pitch up to a higher than normal rotor 25 speed, such as a tip speed of Mach 0.8. Regardless of what the pilot selected, the controller holds rotor blades 29 at a zero or near zero collective pitch during pre-rotation to reduce the required horsepower. After the clutch is released, the controller increases the collective pitch to the pre-selected take-off pitch. [FIG. 8 shows the notional relationship between airspeed and rotor pitch, rotor RPM, and Mu. At any point on the Mu landing curve, one can determine the desired blade pitch by traveling vertically on the graph until one crosses the pitch vs airspeed curve. At that point travel to the right and read the corresponding blade pitch.]

The freewheeling rotor 25 lifts the aircraft until propeller 37 (FIG. 1) can provide sufficient forward speed to maintain flight. The combination of tip weights 31, blades 29 and the high pre-rotational speed for rotor 25 provides an adequate amount of stored energy to drive rotor 25 a sufficient amount after liftoff.

The pilot can select how aggressive a take-off is desired by the level of over speed of rotor 25 and the selection of take-off collective pitch. For example, if the pilot were to prefer a short rolling takeoff because he does not need to make a jump takeoff and he does not wish to take the time for the rotor to spin up to its maximum RPM, then the pilot may input an initial collective pitch between 5 and 9 degrees and pre-rotate rotor 25 to a lesser amount than maximum. For a maximum performance jump takeoff, rotor 25 RPM is increased to its maximum and collective pitch 23 is set to its maximum takeoff setting, between 9 and 12 degrees.

The controller causes blades 29 to move to the selected or optimized take-off pitch immediately upon lift-off. However if an initial pitch setting would cause the rotor blade to see “critical Mach” (higher than normal drag) or the takeoff “g” forces to be excessive, then the controller could reduce the pitch to a lower value and then as the RPM decreased, increase the pitch as required to optimize the takeoff performance. Otherwise the controller will hold blades 29 at the desired take-off collective pitch or pitches, even if it is below the pitch vs Mu curve of FIG. 7. The selected pitch corresponds to a particular Mu on the Mu vs pitch curve of FIG. 7. When the actual Mu of the aircraft reaches the particular Mu, the controller will thereafter follow the pitch vs Mu curve until the aircraft has landed and the rotor clutch is engaged to prerotate the rotor for another take-off.

For example, if the pilot selects a take-off collective pitch of 6 degrees, the particular Mu corresponding to that take-off collective pitch on the curve of FIG. 7 is 0.2. At liftoff, the controller will thus hold the collective pitch at 6 degrees until Mu equals 0.2, then the controller will begin decreasing the collective pitch as Mu increases to follow the slope of the curve. For example when the actual Mu is about 0.4, the controller will move the collective pitch to approximately 3.5 degrees. The controller will actuate cylinder 65 (FIG. 3) to move collective tee 49 upward and downward relative to spindle axis 51 to maintain the pitch according to the curve of FIG. 7. As collective tee 49 moves upward, it causes push rods 45 and pitch horns 43 to move downward, decreasing the collective pitch.

If rotorcraft 11 has wings, such as wings 21 that produce lift, rotor 25 can be unloaded as wings 21 produce more lift after take-off. To reduce rotor lift and keep the net lift constant, the pilot pushes forward on the control stick (not shown), causing rotor 25 to tilt forward relative to the rotor mast or shaft 67. Moving the control stick forward also moves horizontal stabilizer 20 (FIG. 1) to pitch the aircraft 11 down. The control stick normally does not cause mast 67 to tilt, rather this is accomplished by the controller, unless overridden by the pilot. While rotor 25 is still producing some of the lift, the controller may move tilting mast 67 with tilt cylinder 71 (FIG. 3) as required to keep wings 21 (FIG. 1) operating at their best L/D (lift over drag) angle of attack until the minimum rotor RPM is reached. When rotor 25 is substantially unloaded and all of the required lift is supplied by wings 21, the controller causes cylinder 71 to tilt mast 67 to maintain this minimum RPM. Note the pilot could manually increase this minimum RPM of rotor 25 by cyclic pitch control if improved control response is desired, such as might occur during a military action to avoid harm.

As rotor 25 is tilted forward, there is less air flowing through rotor 25 to drive it, causing it to slow down. This lower RPM of rotor 25 and/or an increase in airspeed of aircraft 11 causes a corresponding increase in Mu, which may cause the controller to decrease collective blade pitch if the Mu is still below the upper region, which begins approximately 0.7 as indicated in FIG. 7. Likewise if Mu drops below the upper region, then the controller will increase collective pitch to maintain the relationship on the curve of FIG. 7. By programming the Mu versus collective pitch curve of FIG. 7 into the controller, flapping angle 75, illustrated in FIG. 6, is maintained within a safe operating range of preferably between 1 and 4 degrees.

The relationship between the tilt of rotor 25 and horizontal stabilizer 20 (FIG. 1) can be set so that when Mu is at a selected upper level, such as about 0.75, the airspeed will be such that wings 21 provide most of the lift. Preferably, as Mu increases above this upper level point, the rotor blade collective pitch remains substantially constant in the 1.5 degree to minus 0.5 degree range, as illustrated in FIG. 7. As the aircraft air speed increases and the pilot pushes the control stick forward to keep from climbing, the tilt of rotor 25 relative to the airstream will decrease, causing the rotor RPM to continue to drop. The relationship between airspeed and rotor RPM can be observed in FIG. 8.

In the preferred embodiment, as mentioned, the controller also operates to trim rotor 25 in the fore and aft directions by tilting mast 67 to maintain the rotor RPM at a selected minimum value regardless of the Mu. The controller will provide input to cylinder 71 to increase and decrease the rotor tilt (mast tilt) and thus the rotational speed of rotor 25 to keep the rotor speed at its minimum level during high speed forward flight.

As the aircraft slows down for landing, the pilot tilts rotor 25 aft as required to maintain lift, which increases the speed of rotor 25. Both decreasing speed and increasing rotor RPM decreases Mu. As previously mentioned, there is an upper Mu level of about 0.75 above which the controller maintains the collective pitch generally constant. When operating below this upper level of Mu, the controller will increase the collective pitch in response to a decrease in Mu according to the curve of FIG. 7 until the aircraft lands.

In general, the controller varies the blade collective pitch as a function of Mu, such that at some Mu associated with a minimum straight and level forward speed such as 30 mph, Mu equals the highest blade pitch that will allow auto-rotation, such as 9 degrees. At a Mu greater than a selected amount, such as 0.75, the collective pitch will be low, such as 1.5 degrees positive to about minus 0.5 degree. Varying the collective blade pitch in accordance with this function will restrain blade flapping within a desired amount, such as approximately 1 to 4 degrees. FIG. 4 illustrates schematically the flapping angle 75. FIG. 7 illustrates an example of a curve or relationship between collective pitch and Mu that if utilized, will maintain flapping within the desired amount. Although termed “curve”, the curve of FIG. 7 could be straight or curved. FIG. 8 shows the relationship between Mu and pitch in a different and more detailed manner, with the right side of the graph being both collective pitch and Mu. The units on the right side refer to degrees or to ten times Mu. For example, the unit 4 would be 0.4 Mu.

### Automatic Mechanical Collective Pitch

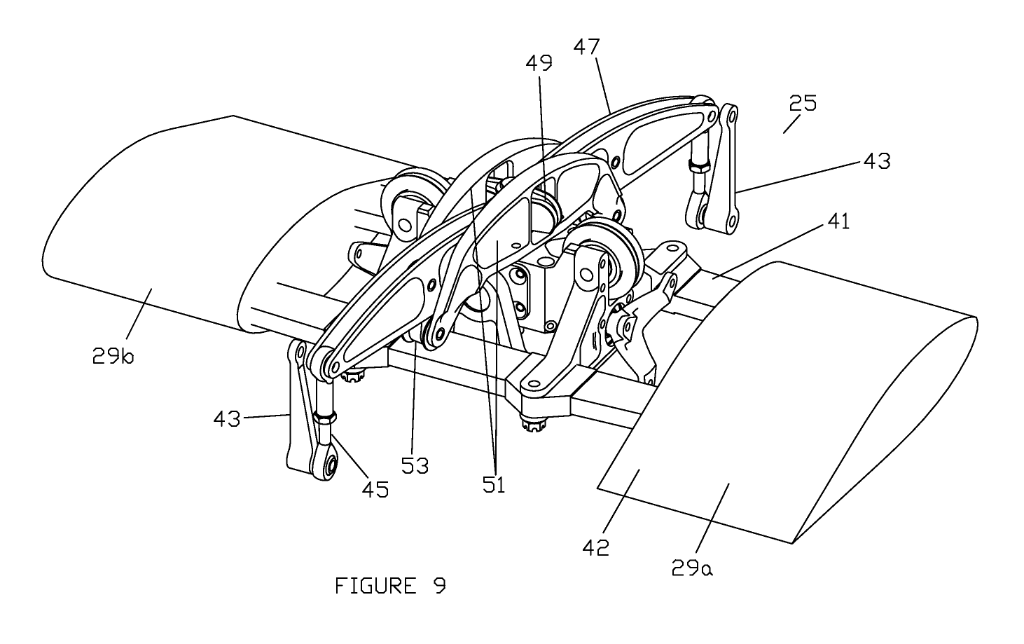

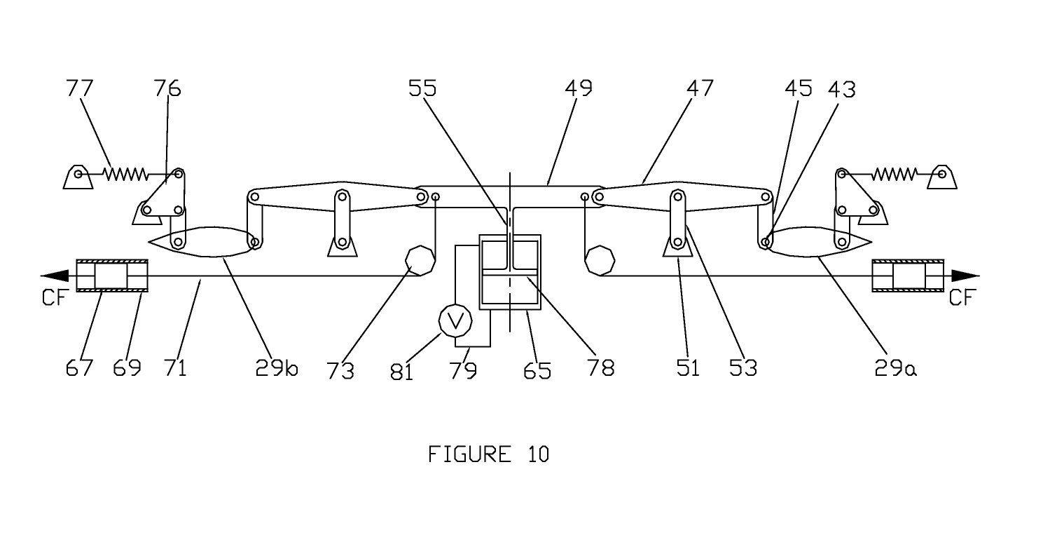

FIGS. 9 and 10 illustrate the components of a different embodiment of the collective pitch assembly. Blades 29 preferably have two spar caps 41 that extend within a shell 42. Spar caps 41 are made up preferably of unidirectional high strength fibers in a composite matrix, and each extends from near the tip of blade 29a to near the tip of blade 29b. Spar caps 41 join each other toward the tips of blades 29, but separate in the central or hub region. Preferably each shell 42 is integrally joined to one of the hub half portions 35 (FIG. 1). A pitch horn 43 is secured to each shell 42 of each blade 29. Each pitch horn 43 can be located either forward or aft of the pitch axis, but as shown is located forward of pitch axis 39 (FIG. 2). When moved up and down, each pitch horn 43 will twist shell 42 relative to spar caps 41 in the central region. The twisting blade shells 42 cause the change in pitch about pitch axis 39 (FIG. 2).

Each pitch horn 43 is pivotally connected to a pitch link 45, which in turn is connected to a pitch link arm 47. Pitch link arm 47 is pivotally mounted to a cross arm 49 that is located on piston rod 55 shown in FIG. 10. Cross arm 49 is able to reciprocate up and down relative to support 51. Links 53 are mounted between support 51 at a mid-point along each pitch link arm 47. When cross arm 49 moves downward, links 53 serve as fulcrums to cause pitch links 45 and pitch horns 43 to move upward in unison. Similarly, when cross arm 49 moves upward relative to support 51, pitch horns 43 move downward in unison. Cross arm 49 is attached to a piston rod 55 that is raised and lowered using hydraulic cylinder 65.

Referring to FIG. 10, a collective weight 67 is carried by each blade 29 for lengthwise movement along blade 29. Collective weight 67 is preferably carried on or by a slide 69, which is illustrated to be a tube, but it could be other types of support structure. Centrifugal force due to the rotation of blades 29 will force collective weights 67 to slide outward on slides 69. A linkage, such as cable 71, attaches to the inner end of each collective weight 67. Each cable 71 extends inward from one of the collective weights 67 around a guide member, such as pulley 73, and up to cross arm 49. As weights 67 move outward, they pull cables 71, and thus cross arm 49 and piston rod 55 downward. Other guide devices, such as cam mechanisms, may be employed instead of pulleys 73 for causing the downward movement of cross arm 49 in response to an outward pull on cables 71. Pulley 73 simply turns the direction of force of cable 71 from outward to downward, thus it is considered to be a linear responsive guide member. If cable 71 were connected to a guide member that is a cam mechanism such as a bell crank, which in turn is connected to cross arm 49, the response could be tailored to be non linear, if desired. That is, the downward movement of cross arm 49 could move non linearly relative to the outward and inward movement of cables 71, if such were utilized.

Preferably, weights 67 are biased to an inward position by springs 77. In this embodiment, each spring 77 is connected to one of the blades 29 through a bell crank 76 to provide a means of tailoring the reaction force to a desired nonlinear response. Each spring 77 exerts a twisting force on one of the blades 29 about the pitch axis 39 (FIG. 2) that is opposite to the force exerted by cables 71 when collective weights 67 move outward. The force or moment created by spring 77 and bell crank 76 can be varied nonlinearly with collective pitch changes. Without bell crank 76, spring 77 would exert a force in reaction to the outward pull by collective weights that is linear with the forces exerted by collective weights 67. Bell crank 76, however, has two pivot points that are selected so that the force exerted by spring 77 is nonlinear relative to the outward pull by collective weights. Devices other than bell cranks, such as cams, can cooperate with spring 77 to create a desired non linear response. Bell crank 76 is considered herein to be a type of a cam mechanism. When collective weights 67 move outward, they cause cross arm 49, piston rod 55, and piston 78 to move downward. The downward movement of cross arm 49, piston rod 55 and piston 78 causes pitch horns 43 to move upward, increasing the collective pitch of blades 29.

Referring still to FIG. 10, hydraulic cylinder 65 includes a piston 78 contained therein. Piston 78 defines an upper chamber and a lower chamber in cylinder 65 containing a hydraulic fluid that resists movement of piston 78. When piston 78 cannot move, piston rod 55 and cross arm 49 cannot move, and thus no change can be made to the collective pitch of blades 29. A bypass line 79 extends around piston 78 from the upper chamber to the lower chamber in hydraulic cylinder 65. Bypass line 79 allows fluid to flow from one chamber to the other to enable piston 78, piston rod 55 and cross arm 49 to move linearly. A valve 81 selectively closes bypass line 79 to lock out the automatic pitch control mechanism. Bypass line 79 has an orifice sized to limit the flow rate of hydraulic fluid and thus control the speed of movement of piston 78, piston rod 55 and cross arm 49.

Blades 29 are biased to a zero collective pitch position due to springs 77 (FIG. 10). Also, when rotor 25 rotates, centrifugal force is created that tends to flatten any pitch in blades 29 (FIG. 1) or twist in the spar caps 41 (FIG. 9) to a zero collective position. Further, the location of the tip weights 31 (FIG. 1) forward of blade leading edges 33 creates moments tending to urge blades 29 to a zero collective pitch position. In addition, the aerodynamic center of lift of each blade 29 is aft of blade pitch axis 39 (FIG. 2), which urges blades 29 to the zero collective pitch position during rotation. The rotor lift varies from 100% of the gross weight at liftoff to possibly 10% or less of the gross weight at cruise altitude. These various forces create a non linear moment relative to blade pitch.

The collective weights 67, springs 77 and bell crank or cam mechanisms 76 are tailored to counter these various moments to produce a selected blade pitch versus RPM for the gyroplane 11 of FIG. 1. Also, non linear cam mechanisms could also be substituted for pulleys 73, if desired. The collective weights 67 increase the pitch as the rotational speed of rotor 25 increases, and as the rotational speed of rotor 25 decreases, the various moments described above overcome the centrifugal forces on collective weights 67 and decrease the pitch. The rate of increase and decrease of these moments provides blade pitch stability and keeps blade flapping within a desired range.

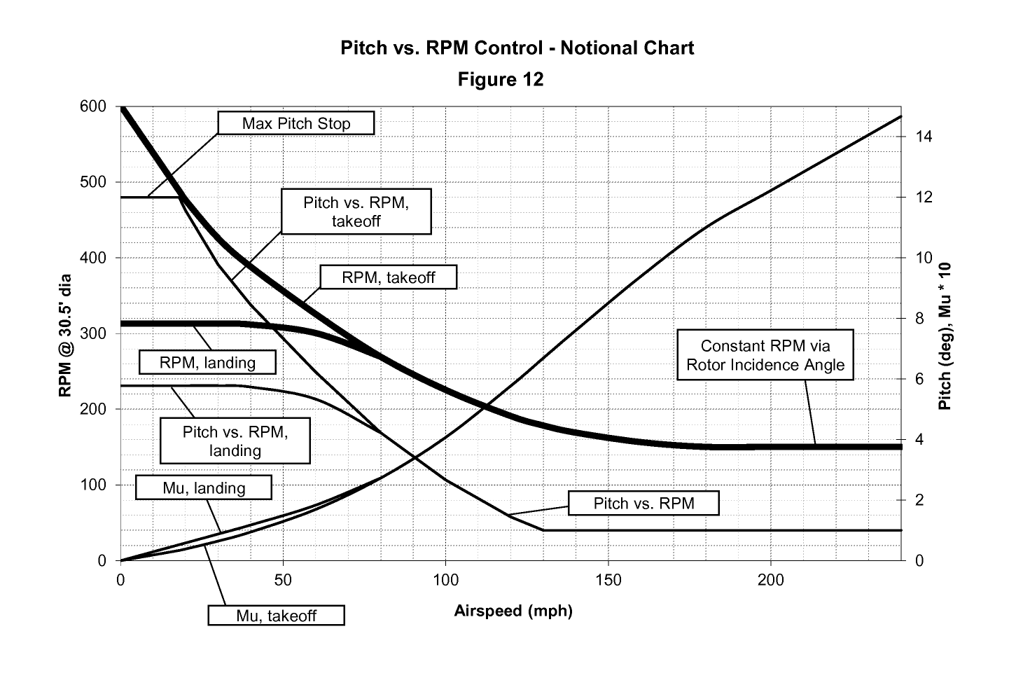

In operation, for takeoff, the pilot will pre-rotate rotor 25 (FIG. 1) to an over-speed such as 650 RPM or a tip speed of about Mach 0.8. To keep rotor 25 from producing lift during the spin-up, rotor 25 and propeller 37 (FIG. 1) are maintained at near zero collective pitch during pre-rotation. Valve 81 (FIG. 10) is closed, blocking any movement of piston 78 in cylinder 65. Piston rod 55 and cross arm 49 are thus held in a near zero collective position. The collective pitch of propeller 37 (FIG. 1) can be maintained near zero by a similar arrangement or by a manual arrangement while valve 81 is closed. The graph in FIG. 12 illustrates the pre-rotation as being at zero collective pitch. The over-speed rotation stores kinetic energy for a jump takeoff.

Once rotor 25 is up to the desired over-speed, and the clutch driving rotor 25 is disconnected from the engine, valve 81 is opened. This allows all of the horsepower to now drive propeller 37 (FIG. 1). The centrifugal force on collective weights 67 causes piston rod 55 and cross arm 49 to move downward as weights 67 move outward. As shown in FIG. 12, the pitch will increase to a first level, such as around 6 degrees, at which aircraft 11 begins to lift. The pitch then increases more gradually up to a maximum, between 9 and 12 degrees, as aircraft 11 lifts and advances forward. Meanwhile, the RPM of rotor 25 will be decreasing because it is no longer driven by the engine, but rather from the stored up inertia in the rotor blades. Initially at liftoff, rotor 25 may be tilted slightly forward so the rotor lift will have a forward component to help accelerate the aircraft and then as the RPM slows the rotor will be tilted aft as required to provide the required lift. Tilting rotor 25 aft causes air to flow through the rotor from the lower side, which now provides the required rotor autorotation driving force. As the aircraft accelerates, wing 21 provides more of the lift, allowing the rotor lift to decrease. To reduce the net lift, required to keep from climbing, the pilot tilts rotor 25 forward so less air flows through the rotor, which decreases its RPM and lift.

As shown in FIG. 12, in this embodiment, the aircraft velocity reaches a point after which the rotor RPM and the collective pitch decrease relative to an increase in aircraft velocity. In this example, the rotor RPM and blade collective pitch decrease as the aircraft speed increases from around 30 mph to about 150 mph, although it is not essential that the relation of rotor RPM and blade collective pitch be linear relative to aircraft speed. As discussed above, the collective pitch will decrease due to the various moments around pitch axis 39 (FIG. 2) tending to flatten blades 29, and the centrifugal forces on collective weights 67 will control the rate at which the pitch changes. As the pitch decreases, cross arm 49 and piston rod 55 move upward with piston 78. The upward movement of cross arm 49 pulls cables 71, causing inward movement of collective weights 67. Springs 77 and bell crank/cam 76 apply additional forces to urge collective weights 67 inward. Eventually at a speed shown in the example of about 150 mph, when the rotor advance ratio is greater than about 0.7, the collective pitch will be at a given design pitch between 1.5 and minus 0.5 degrees and will remain constant as the aircraft speed increases. The pilot maintains the RPM of rotor 25 at a selected minimum level by controlling the tilt of rotor 25. The given minimum pitch is selected to assure rotor flapping is always at an acceptable level, and if the rotor RPM should drop below its desired RPM, tilting rotor 25 aft slightly will increase its RPM.

For landings, the operator will tilt rotor 25 aft, which causes more air to flow through rotor 25, increasing the speed of rotation. The increase in speed of rotation causes collective weights 67 (FIG. 10) to move outward due to the increase in centrifugal force. The centrifugal force overcomes the non linear force of springs 77 through bell crank/cam mechanism 76, which causes a downward movement of piston rod 55 and cross arm 49. This downward movement pulls pitch horns 43 upward, increasing the pitch gradually as the rotor RPM increases. The aircraft speed will slow as rotor 25 provides more of the lift and wings 21 less. The high collective pitch enables a vertical descent of aircraft 11 at about the same speed as an equivalent diameter parachute of which a high energy absorbing landing gear can safely absorb. Soft landings can be performed using a slow speed approach followed with a landing flare.

### Controller Collective Pitch in Response to RPM for Slowed Rotor Aircraft

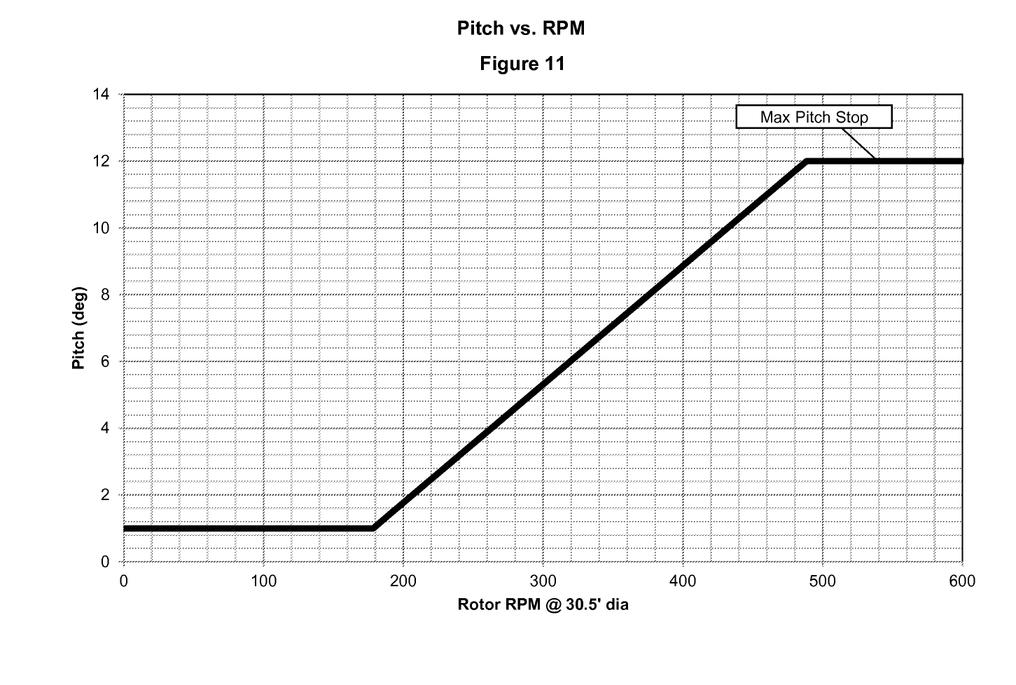

In an embodiment utilizing a controller and actuator that can control rotor pitch, such as shown in FIGS. 5 and 6 and described above, an alternative method to controlling the collective blade pitch as a function of Mu is to control the collective blade pitch as a function of RPM. Because the controller already maintains rotor rpm relative to airspeed by tilting the rotor as described previously, this still results indirectly in a desirable pitch for the conditions to restrain flapping within a desired amount. FIG. 11 illustrates an example of a curve or relationship between collective pitch and rpm when rpm is a function of airspeed that if utilized, will maintain flapping within the desired amount. FIG. 12 shows the relationship between RPM and pitch in a different and more detailed manner, with the right side of the graph being both collective pitch and Mu. The units on the right side refer to degrees or to ten times Mu. For example, the unit 4 would be 0.4 Mu. This method of collective blade pitch control results in a pitch vs. Mu curve very similar to that which results from directly controlling pitch vs. Mu.

### Selective Lock of Collective Pitch for Landing Slowed Rotor Aircraft Having Automatic Mechanical Pitch Controller

In an embodiment using the automatic mechanical collective, such as shown in FIGS. 9 and 10 and described above, a slightly more sophisticated control strategy can be used to provide improved landing and aborted landing performance. After the aircraft has accelerated to a sufficient airspeed, the rotor pitch will be at its minimum value between 1.5 and minus 0.5 degrees. As the aircraft slows and the rpm begins increasing again, the rotor pitch will also begin to increase in the manner described previously. At a certain desired pitch, the valve 81 is closed, locking the rotor at that pitch. Then, as the aircraft continues to slow and the rotor rpm increases further, the blade pitch will stay constant. Because of the lower pitch, the rotor will spin faster than if the rotor pitch were still able to increase, creating slightly higher drag and higher descent rates, but this would not be a major detriment to aircraft performance. Additionally, this difference in RPM represents an excess energy stored in the rotor's inertia. This provides a measure of collective control to the pilot during the landing approach. If for any reason the pilot needs to abort the landing and perform a go-around, the valve 81 can be opened, allowing the rotor pitch to increase. This will provide an immediate increase in rotor lift, greatly slowing the descent rate, or even providing a positive climb depending on the circumstances.

### Collective Blade Pitch Actuators Located in Rotor

Several types of rotorcraft incorporate collective rotor blade pitch control, allowing the pilot to directly control the lift produced by the rotor. Blade pitch control is an essential element for the control of conventional helicopters, and for gyroplanes, it is necessary to be able to perform jump takeoffs and to also provide finer control during landing.

Most gyroplanes utilize a tilting spindle, which rotates, for rotor control. A rotor that is teetering is mounted to one end of the spindle, and the other end of the spindle is mounted to a non-rotating spindle housing. The spindle housing is mounted to a gimbal, allowing both the spindle housing and the spindle to be tilted. In some aspects, control links are attach to the spindle housing to allow the pilot to control the tilt of the spindle, which causes the rotor disc to tilt the same direction and thereby controls the aircraft. In such a system, if collective pitch control is included, it is usually through a push-pull shaft running up through the center of the rotor head to operate linkages in the rotor head to change the collective pitch of the rotor blades. This type of collective control presents several challenges. Even though a gyroplane rotor, for example, is not powered directly by the engine in flight, there is typically a means to prerotate the rotor on the ground to accelerate its rotational velocity to some operational rpm. While this is sometimes an electric motor in light gyroplanes, it is typically a mechanical connection to the engine in heavier gyroplanes. i.e. a drive shaft. To operate properly, the drive shaft must include some sort of flexible coupling to allow the degrees of freedom necessary for spindle tilt. The push-pull shaft for collective control is typically run concentrically through the drive shaft, also requiring some flexible coupling to accommodate the spindle tilt. Maintaining proper kinematic relationships and clearance is a challenge with this type of setup, particularly with the flexible coupling in the drive shaft. The challenge is exacerbated in rotorcraft with tilting masts such as those used for slowed rotor compound aircraft.

The subject of this disclosure describes an alternative method of collective blade pitch control. An actuator is mounted in or proximate the rotor blades. By applying load to appropriately configured linkages or linkage assemblies, the actuator can pitch the blades to higher and lower pitch settings. These actuators can be electric, hydraulic, or any other means that allows for actuation. In one embodiment, the actuation is a linear actuation. The connectors, which may be wires or lines, that are run to the rotor are more flexible and easier to route than the push-pull shaft of a more conventional collective control. While the embodiment illustrated is a gyroplane, it will be appreciated by one of skill in the art that mounting actuators in the rotor to affect rotor blade pitch may be used in any type of rotorcraft.

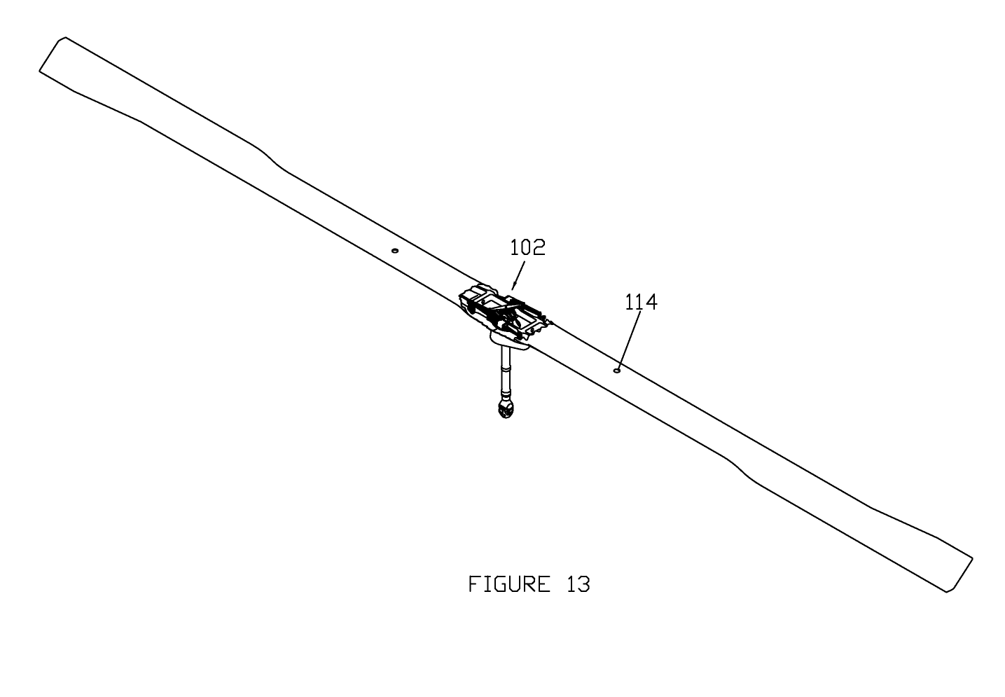

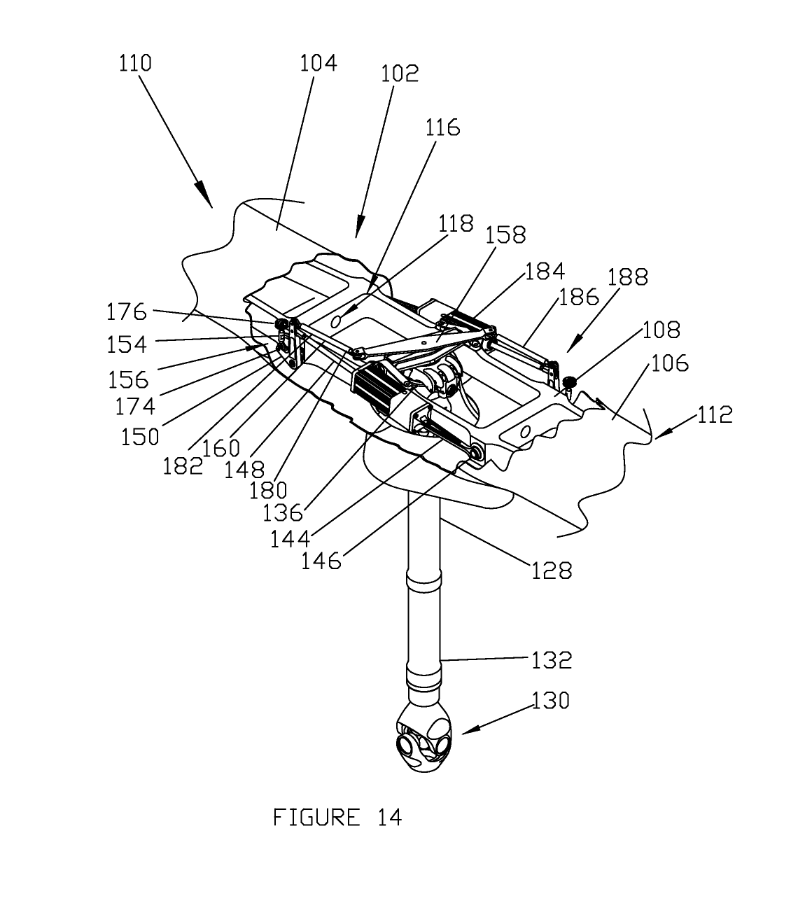

Referring to FIGS. 13-17, and more specifically to FIGS. 13-14, there is presented a rotor 102 that is operable to produce substantially all of the lift of a rotorcraft 11 (FIG. 1) during at least a portion of flight. In this specific, non-limiting embodiment, the rotor 102 is comprised of three primary structural elements—a first and second blade skin 104, 106 and one flex beam 108. The first blade skin 104, the portion of the flex beam 108 surrounded by the first blade skin 104, and other components surrounded by the first blade skin 104 may be referred to as a first blade 110. Likewise, the second blade skin 106, the portion of the flex beam 108 surrounded by the second blade skin 106, and other components surrounded by the second blade skin 106 may be referred to as a second blade 112. In one embodiment, the flex beam 108 may be referred to as a spar. In other embodiments not shown but well known in the art, the rotor may include a hub configuration that includes a hub with two or more blades attached to the hub and operable to twist via hub bearings.

In the embodiment shown, a main attachment means of the blade skins 104, 106 to the flex beam 108 is at a pin joint 114 located at length that is approximately ⅕ to ¼ of the blade radius. The pin joint 114 essentially transfers all of the centrifugal load acting on the blade skins 104, 106 into the flex beam 108. A secondary attachment means occurs near the root 116 of the blade, where a small pin joint 118 includes a pin (not shown) that extends into a spherical bearing (not shown) anchored to the flex beam 108. The small pin joint 118 restrains the respective blade 110 or 112 from rotating about the primary pin joint 114.

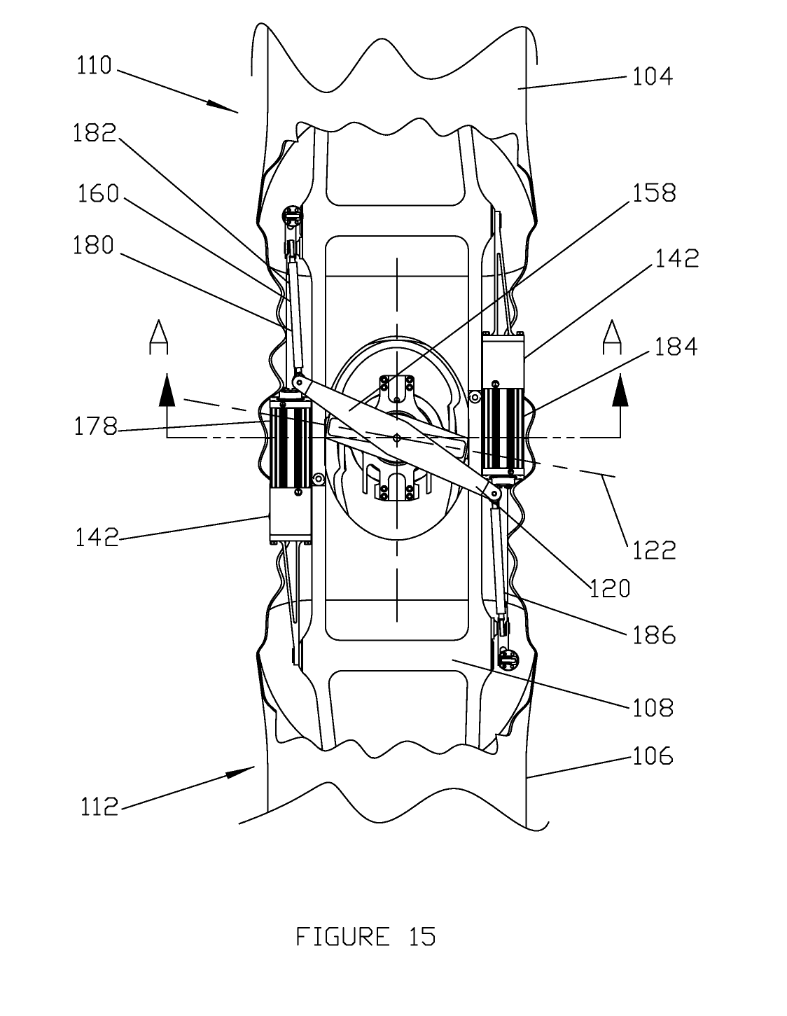

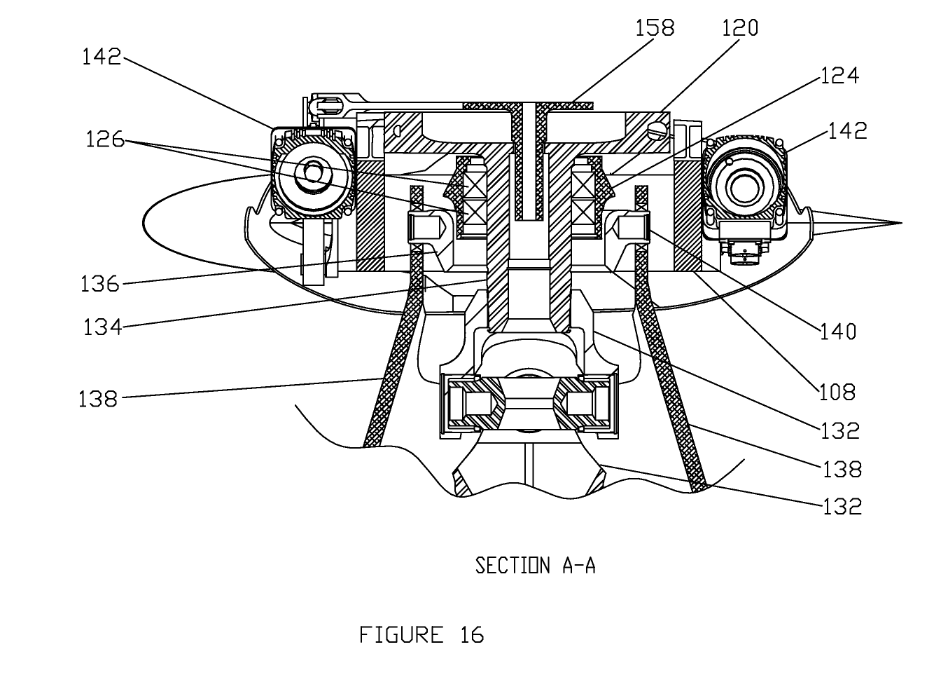

Referring still to FIGS. 13-17 with particular reference to FIG. 16, the flex beam 108 is attached to a spindle 120, which is operable to tilt, through two teetering bearings (not shown), defining the teetering axis 122 (FIG. 15) of the rotor 102. The teetering bearings allow the rotor 102 to teeter about the teetering axis 122, also known as flapping. The spindle 120 is mounted to a non-rotating spindle housing 124 through thrust bearings 126 that can carry the lift load, while the lower portion of the spindle 120 is attached to a first end 128 the rotor drive shaft 132 through a spline joint 134. The other end or second end 130 of the drive shaft 132 is connected to an engine (FIG. 1). The spindle housing 124 is mounted to a gimbal 136 through two bearings 140 that allow side-to-side tilt, and the gimbal 136 is mounted to a mast 138 through two bearings (not shown) that allow fore-and-aft tilt.

Referring now primarily to FIG. 14, in one, non-limiting embodiment, there are two actuators 142 to collectively control blade pitch. In a specific embodiment, one end 144 of each actuator 142 is attached to a support 146 anchored to the flex beam 108. The other end 148 is attached to a bell crank 150. The bell crank 150 pivots about a support 152 anchored to the flex beam 108. As the actuator 142 moves, the bell crank 150 moves a pitch link 154, which is attached to the blade skin 104 or 106, changing the collective pitch of the blades 110, 112 (FIG. 2). The bell crank 150 and the pitch link 154 may be referred to collectively as a pitch linkage assembly 156. To ensure that the pitch is synchronized between both blades 110, 112, the bell cranks 150 may be tied together through a crosstie lever 158 and two crosstie linkages 160. In another embodiment, the actuators 142 are positioned adjacent to, proximate to or on a portion of the rotor blades 110, 112. In one, non-limiting embodiment, the actuators 142 are electric servos.

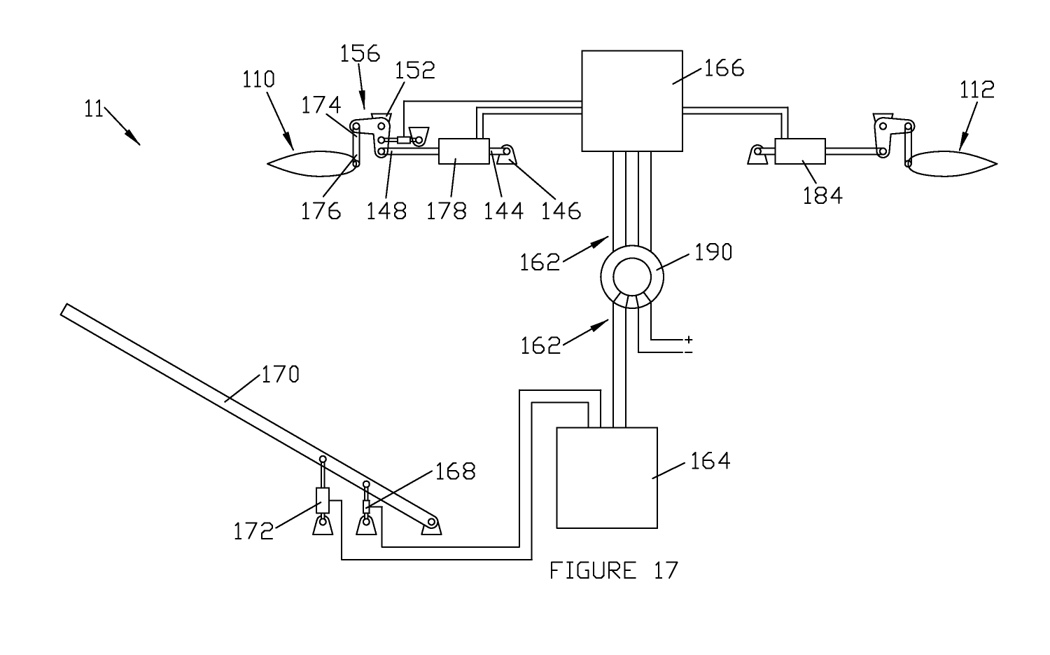

Referring now primarily to FIG. 17, a system for controlling blade pitch is presented. The system includes a first control box 164 and may further include a second control box 166. The first control box 164 is connected to a collective lever sensor 168 that is connected to and monitors a collective lever 170. The collective lever sensor 168 monitors the position of the of the collective lever 170 and sends data to the first control box 164. In one embodiment, the first control box 164 may further be connected to a control lever actuator 172, operable to move the collective lever 170 in response to commands issued by the first control box 164. The control lever actuator 172 in conjunction with the first control box 164 may automatically control the collective pitch lever 170 and the collective pitch of the blades based on data received by the first control box 164, such as collective lever position, flapping, pitch angle, etc.

The system may further include the second control box 166 where the second control box 166 is in communication with the first control box 164 and acts to send commands or power to the actuators 142. In the absence of the second control box 166, the first control box 164 may send commands and power to the actuators 142. The second control box 166 may further act to collect data from sensors in the rotor 102 and communicate collected data to the first control box 164. The first and second control boxes 164, 166 are operable to both send and receive information to each other.

One or more wires or connectors 162 may run up through the rotor drive shaft 132 to control and monitor the rotor 102. In one embodiment, there are four connectors 162 or wires that function as power, ground, data transmit, and data receive. These wires 162 run into the second control box 166. Depending on the commands sent to the second control box 166 over the data wires 162, the control box 166 will send the appropriate power to control the actuators 142. The second control box 166 also receives input from various sensors in the rotor 102, such as blade pitch, flapping, and load cells, encoding the sensor data into a digital signal to send back to the main aircraft computer.

This system can be operated in at least two manners. The simplest is “fly-by-wire”, where the pilot controls the collective lever 170 in the cockpit, and the control system adjusts the collective actuators 142 to match the commanded input from the pilot. A second strategy is for the collective to be completely automated. The pilot would have means to specify specific commands, such as hitting a button to command takeoff, but the controllers 164, 166 would automatically set collective pitch based on algorithms incorporating various parameters from the aircraft. The preferred embodiment is a hybrid of these two strategies. The pilot will have a button on the control stick to command takeoff, and a collective lever 170 to be able to manually set the collective when desired. The collective lever 170 will be driven by the actuator 172, such that when the collective is being operated automatically, the actuator 172 will drive the collective lever 170 to match the actual collective blade pitch of the rotor. A button on the end of the collective lever will put the system into manual mode, allowing the pilot to manually set collective. Another button on the dash will put the collective back into automatic mode. The intended operation would be to operate the collective automatically for all modes from takeoff to final approach, and then only use the manual override for landing if the pilot felt the need.

In one embodiment, the one or more actuators 142 are affixed to the rotor blades 110, 112. In some aspects of the system, the one or more actuators 142 are affixed to the flexible beam 108.

In some aspects, the system further includes the bell crank 150 attached to the actuator 142, and the pitch linkage 154 having a first end 174 attached to the bell crank 150 and a second end 176 attached the blade skin 104 or 106, wherein the blade skin 104 or 106 is part of the blade 110 or 112. The actuator 142 operates to move the bell crank 150 causing the pitch linkage 154 to move, thereby causing the blade skin 104 or 106 to rotate about to change the blade pitch Θ of the blade 110 or 112.

In some aspects, the system further comprises a first actuator 178 attached to a portion of the spar 108 located in the first blade 110, the spar 108 covered by the first blade skin 104, and a first pitch linkage 180 assembly connected to the first actuator 178, a first cross link 182 and the first blade skin 104; a second actuator 184 attached to a portion of the spar 108 located in the second blade 112, the spar 108 covered by the second blade skin 112, and a second pitch linkage 186 assembly connected to the second actuator 184, a second cross link 188 and the second blade skin 106; and the cross lever 158 connected to the first and second cross links 182 and 188.

In some aspects, the system further comprises a slip ring 190 positioned proximate the first end of the drive shaft for feeding connectors to the second control box to prevent the connectors from becoming tangled as the drive shaft rotates.

In a second embodiment, a system for adjusting a blade pitch in a rotorcraft, comprises a rotor having two or more blades; and one or more actuators operably connected to at least one of the blades to change a blade pitch.

In some aspects, the system further comprises a collective lever arm operable to move, the movement operable to cause the blades to change their respective blade pitch; a collective lever arm sensor attached to the collective lever arm to sense a position of the collective lever arm; a collective lever arm actuator attached to the collective lever arm operable to automatically move the collective lever arm; a first control box connected to the collective lever arm sensor to receive data from the collective lever arm sensor and connected to the collective lever arm actuator operable to send command signals to the collective lever arm actuator causing the collective lever arm actuator to move the collective lever arm; a second control box connected to the first control box via connectors to provide communication between the first and second control boxes, the connectors positioned through a slip ring, the second control box connected to the one or more actuators operable to send command signals and power to the one or more actuators and receive data from the one or more actuators; and a pitch sensor positioned adjacent a pitch linkage, the pitch sensor in communication with the second control box for sending pitch angle data to the second control box.

In operation, a method for controlling blade pitch in a rotorcraft, comprises receiving data input from one or more sensors; and sending a command to an actuator positioned in the rotor and operably connected to a pitch linkage to move the pitch linkage thereby changing a pitch angle of a rotor blade. In some aspects of the method, the step of receiving the data input from the one or more sensors is responsive to changing the pitch angle of the rotor blade. In some aspects of the method, the data input relates to pitch angle. In yet some aspects of the method, the step of sending the command to the actuator is responsive to receiving the data input from the one or more sensors. In some other aspects of the method, the data input relates to a position of a collective lever. In still some aspects, the method further comprises collectively changing the pitch angle of all rotor blades attached to the rotorcraft.

Another method of operation for adjusting blade pitch of a blade in a rotorcraft includes the steps of moving a collective lever; sending position data to a control box indicating a position of the collective lever; and sending a predetermined amount of power to an actuator positioned in a rotor head based on the data sent to the control box causing the actuator to move a pitch linkage attached to the blade a correspondingly predetermined distance, thereby changing the blade pitch of the blade. In one aspect, the method further includes sending blade pitch data to the control box indicating the a pitch angle of the blade; commanding, the command sent from the control box, an actuator attached to the collective lever to move the collective lever thereby causing the pitch angle of the blade to change; and responsive to moving the collective lever, sending new blade pitch data to the control box indicating a new pitch angle of the blade.

Mast Dampener with Non-Linear Spring for a Rotorcraft

This description relates in general to rotor aircraft, in particular to the attachment of the rotor system, which includes the mast and the rotor, to the fuselage, and specifically a non-linear spring to reduce resonance. The subject of this description is a mast-fuselage attachment mechanism that utilizes a non-linear spring to reduce resonance in the rotorcraft.

In a linear system, natural frequency can be determined by modeling the system as a simple harmonic oscillator. In such a system, the natural frequency can be determined with the following equation: ω=√(k/m). In this equation, co is the natural frequency, k is the spring rate, and m is the mass of the system. Note that the natural frequency is independent of the amplitude of the oscillation. If a driving frequency matches the natural frequency, this will lead to a resonance. In an underdamped system, the amplitude of vibration can increase until the amplitude of vibration becomes catastrophic.

A system with a non-linear spring behaves differently. The amplitude of the oscillation does affect the resonant frequency. This frequency shift is defined by the formula: ω=ωₒ+κA². In this equation, ωₒ is the base natural frequency, κ is a constant, and A is the amplitude of the oscillation. So, even in the event that a driving frequency caused the system to oscillate, an increased amplitude would change the natural frequency of the system so that natural frequency no longer matched the driving frequency, self-limiting the maximum amplitude. The non-linear spring may act as a damper by limiting the resonance in the rotor system or by preventing resonance from staying in the rotor system because the driving frequency causes the natural frequency to dynamically change so that the two frequencies do not match.

Referring to FIGS. 1-5, an illustrative, non-limiting embodiment of an attachment mechanism 102 for changing the natural frequency of a rotor system 104 implemented in a rotorcraft 106 is described. The rotorcraft 106 illustrated in FIG. 1 is a gyroplane having a tilting mast, and, more specifically, is a slowed-rotor compound aircraft similar to the aircraft described in U.S. Pat. No. 7,137,597, incorporated herein by reference. It will be appreciated, however, by one of ordinary skill in the art that the rotorcraft 106 may be any known rotorcraft, including helicopters, gyroplanes, compound helicopters, or compound gyroplanes.

The rotorcraft 106 comprises an airframe or fuselage 108 attached to the rotor system 104 via the attachment mechanism 102. The rotor system includes a mast 110 that is attached at a first end 112 to a rotor 114. The mast 110, at a second end 116, is attached to the fuselage 108. The attachment mechanism 102 includes non-linear springs 118 operable to change the natural frequency of the rotor system 104 to prohibit any oscillation occurring in the rotor system 104 from amplifying to catastrophic levels.

In one non-limiting embodiment, the non-linear springs 118 are elastomeric elements 120. One skilled in the art will appreciate that other elements and configurations may be used that will function as a non-linear spring 118. For example, a properly tailored set of springs in series, such as a Belleville washer stack-up, could be made to increase spring force as lighter springs bottomed out and only heavier springs were able to deflect.

The shape of the non-linear springs 118 may take numerous shapes so long as the shape functions as a non-linear spring under compression, i.e., the spring rate changes as the non-linear springs 118 are compressed or deformed. For example, if the mast 110 begins to oscillate, the mast 110 will compress the non-linear springs 118 in a manner such that the spring rate of the non-linear springs 118 changes, creating a non-linear spring reaction. In one embodiment, the rounded shape of the non-linear springs 118 allows the non-linear springs 118 to deform under compression in such a way that the non-linear springs' 118 spring rate changes when the non-linear springs 118 are compressed.

Changing the spring rate will offset the natural frequency of the rotor system 104, keeping the oscillation from amplifying. In other words, by dynamically changing the natural frequency of the rotor system 104, the driving frequency is prevented from matching the rotor system's 104 natural frequency. The oscillation may occur in various directions. In the embodiment shown, however, it should be noted that the oscillation of concern will typically be limited to a side-to-side oscillating direction as shown by reference arrows 122, rather than in a fore/aft oscillating direction, as shown by reference arrows 124, because of a pneumatic mast actuation cylinder 126 illustrated in FIG. 2 that is specific to this embodiment. It will be appreciated by one skilled in the art that the non-linear springs 118 may be used regardless of the direction of oscillation. The pneumatic mast actuation cylinder 126 is similar to the pneumatic mast actuation cylinder described in U.S. Pat. No. 7,137,597, preventing a resonance oscillation of the mast in the fore/aft direction.

Referring still to FIGS. 1-5, the mast 110 consists of two side plate 128 and a non-structural fairing (not shown). The rotor 114 is attached to the top 112 of the mast 110. As illustrated in this non-limiting embodiment, the mast actuation cylinder 126 controls the fore/aft position of the mast and restrains motion in the fore/aft direction 124. The mast 110 is attached to an airframe 130 through two attachment fittings 132. The two fittings 132 carry substantially all of the airframe's 130 weight when the rotor 114 is providing substantially all of the rotorcraft's 106 lift.

Referring to FIGS. 3 and 4, the attachment mechanism 102 may include the shuttle 134, a pin 136, endcaps 138 and bushings 140. The mast 110 is rotatably connected to the pin 136 via bushings 140. Shuttles 134 are positioned adjacent the mast 110 with the pin 136 installed in each shuttle 134. The shuttles 134 are positioned in a slot 142 formed in the fittings 132 and are operable to move along a longitudinal axis 144 within the slot 142. The endcaps 138 are attached to the fittings 132 forming a housing 146 that limits the travel of the shuttles 134. The non-linear springs 118 are positioned in the housing 146, and the non-linear springs 118 function to restrain or cushion the movement of the mast 110 relative to the airframe 108.

In specific operation of the above embodiment, the elastomeric elements 120 are the non-linear springs 118 used in connecting the rotor system 104 to the airframe 108. The shape of the elastomeric elements 120 may allow the elastomeric elements 120 to react with a non-linear force vs. deflection. Ignoring deformation of the mast 110 itself, a side-to-side deflection of the mast 110 must be accompanied by compression of the elastomeric elements 120. Because of the elastomeric elements' 120 non-linear response, no particular rotor 114 rpm will be able to cause a large resonance. Even if a resonance begins, the deflection of the elastomeric elements 120 will change the rotor system's 104 spring rate, and the resonance will not be able to build any higher.

Additionally, by using a pneumatic cylinder 126 of sufficient volume, the cylinder's 126 fore/aft spring rate is such that the mast's 110 fore/aft natural frequency is less than a minimum operation rotor rpm, thereby avoiding a resonance oscillation of the mast 110 in the fore/aft direction.

In one aspect, an apparatus to prevent or limit resonance in an aircraft 148 is described. The aircraft 148 includes the rotor system 104 and the airframe 130 and the rotor system 104 and the airframe 130 are operable to move relative to each other as the rotor system 104 begins to oscillate. A non-linear spring 118 is positioned between the rotor system 104 and the airframe 130. The non-linear spring 118 is configured to be deformed when the rotor system 104 and the airframe 130 move relative to each other, such that the deformation of the non-linear spring 118 causes the natural frequency of the rotor system 140 to change. In this embodiment, the rotor system 140 includes the mast 110 and the rotor 114.

In another aspect, the attachment mechanism 102 connects the airframe 130 and the rotor system 104. The rotor system 104 includes the rotor 114 and the mast 110. The attachment mechanism 102 is operable to prevent or limit resonance in the aircraft 148. In this embodiment, the attachment mechanism 102 includes the shuttle 134 having a first end 150 and a second, opposing end 152 configured to be connected to the mast 110. The airframe 148 includes the attachment fitting 132 with the slot 142 formed therein for receiving the shuttle 134 such that the shuttle 134 is operable to move generally along the longitudinal axis 144 of the slot 142. The endcap 138 is configured to be fitted adjacent to the second end 152 of the shuttle 134 and be attached to the attachment fitting 132. The non-linear spring 118 is positioned adjacent the shuttle 134 and operable to deform as the shuttle 134 and the mast 110 move relative to the attachment fitting 132 of the airframe 130.

In yet another aspect, the attachment mechanism 102 connects the airframe 130 and the rotor system 104. The rotor system 104 includes the rotor 114 and the mast 110. The attachment mechanism 102 prevents or limits resonance in the aircraft 148. The attachment mechanism 102 includes the shuttle 134 having the first end 150 and the second, opposing end 152 and is configured to be connected to the mast 110. The airframe 148 has the attachment fitting 132 with the slot 142 formed therein for receiving the shuttle 134 such that the shuttle 134 is operable to move generally along the longitudinal axis 144 of the slot 142. The slot includes ledge 154 such that the ledge 154 and the first end 150 of the shuttle 134 are operable to form a first aperture 156 when the ledge 154 and the first end 150 of the shuttle 134 are positioned adjacent each other. The attachment mechanism 102 further includes the endcap 138 configured to be fitted adjacent to the second end 152 of the shuttle 136 and attached to the attachment fitting 132 such that the end cap 138 and the second end 152 of the shuttle 136 are operable to form a second aperture 158. A first non-linear spring 160 is configured to be positioned in the first aperture 156, and a second non-linear spring 162 configured to be positioned in the second aperture 158. The first and second non-linear springs 160, 162 are operable to deform as the shuttle 136 and the mast 110 move relative to the attachment fitting 132 of the airframe 130.

It should be appreciated that there may be two end caps 138, two shuttles 134, etc. and that a third and fourth non-linear spring 164, 166 and respective apertures 168, 170 may be deployed.

In one aspect of operation, a method for preventing or limiting resonance in the rotorcraft 106 may include the following steps: introducing oscillation into the mast 110 attached to the airframe 108 moveable relative to each other with the non-linear spring 118 positioned between the mast 110 and the airframe 108; the oscillation causing movement of the mast 110 relative to the airframe 108 and compression of the non-linear spring 118; and the compression of the non-linear spring 118 causing the natural frequency associated with the mast 110 to change.

In another aspect of operation, a method for preventing or limiting resonance in the rotorcraft 106 having the rotor system 104 and the airframe 108 may include the following steps: positioning the non-linear spring 118 between the rotor system 104 and the airframe 108, the rotor system 104 and the airframe 108 operable to move relative to each other; causing the rotor system 104 and the airframe 108 to move relative to each other; and deforming the non-linear spring 118 in response to the rotor system 104 and the airframe 108 moving relative to each other, causing a natural frequency of the rotor system 104 to change.

While the invention has been shown in only one of its forms, it should be apparent to those skilled in the art that it is not so limited but susceptible to various changes without departing from the scope of the invention.

While the invention has been shown in only one of its forms, it should be apparent to those skilled in the art that it is not so limited but susceptible to various changes without departing from the scope of the invention.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A system for controlling blade pitch in a rotorcraft, comprising:
a drive mechanism;
a rotor having two or more blades connected to the drive mechanism; and
one or more actuators positioned adjacent to the rotor blades operable to change a blade pitch of the rotor blades.

2. The system of claim 1 further comprising a control box operable to send command signals to the one or more actuators.

3. The system of claim 1 further comprising a first control box connected to a collective lever and a second control box, in communication with the first control box, connected to the one or more actuators.

4. The system of claim 1, wherein a first actuator is connected to a first rotor blade and a second actuator is connected to a second rotor blade.

5. The system of claim 1, wherein the one or more actuators are affixed to the rotor blades.

6. The system of claim 1, wherein the one or more actuators are affixed to a flexible beam.

7. The system of claim 1 further comprising:
a bell crank attached to the one of the one or more actuators; and
a pitch linkage having a first end attached to the bell crank and a second end attached a blade skin, the blade skin being a portion of a blade;
wherein the actuator moves the bell crank causing the pitch linkage to move, thereby causing the blade skin to rotate about a bearing, changing the blade pitch of the blade.

8. The system of claim 1, further comprising:
a first actuator attached to a portion of a spar located in a first blade, the spar covered by a first blade skin, and a first pitch linkage assembly connected to a first actuator, a first cross link and the first blade skin;
a second actuator attached to a portion of the spar located in a second blade, the spar covered by a second blade skin, and a second pitch linkage assembly connected to a second actuator, a second cross link and the second blade skin; and
a cross lever connected to the first and second cross links.

9. The system of claim 1 further comprising a slip ring.

10. The system of claim 9 further comprising a first control box positioned proximate the one side of the slip ring and a second control box positioned proximate a second side of the slip ring, the first control box connected to the second control box via connectors.

11. The system of claim 9 further comprising a slip ring for feeding connectors to the second control box to prevent the connectors from becoming tangled as the rotor rotates.

12. A system for adjusting a blade pitch in a rotorcraft, comprising:
a rotor having two or more blades; and
one or more actuators operably connected to at least one of the blades to change a blade pitch.

13. The system of claim 12 further comprising:
a collective lever arm operable to move, the movement operable to cause the blades to change their respective blade pitch;
a collective lever arm sensor attached to the collective lever arm to sense a position of the collective lever arm;
a collective lever arm actuator attached to the collective lever arm operable to automatically move the collective lever arm;
a first control box connected to the collective lever arm sensor to receive data from the collective lever arm sensor and connected to the collective lever arm actuator operable to send command signals to the collective lever arm actuator causing the collective lever arm actuator to move the collective lever arm;
a second control box connected to the first control box via connectors to provide communication between the first and second control boxes, the connectors positioned through a slip ring, the second control box connected to the one or more actuators operable to send command signals and power to the one or more actuators and receive data from the one or more actuators; and
a pitch sensor positioned adjacent a pitch linkage, the pitch sensor in communication with the second control box for sending pitch angle data to the second control box.

14. The system of claim 12 further comprising:
an engine; and
a drive shaft having a first end and a second end and connected at the first end to the engine;
wherein the rotor is connected to the second end of the drive shaft.

15. A method for controlling blade pitch in a rotorcraft, comprising:
receiving data input from one or more sensors; and
sending a command to an actuator positioned in the rotor and operably connected to a pitch linkage to move the pitch linage thereby changing a pitch angle of a rotor blade.

16. The method of claim 15, wherein the step of receiving the data input from the one or more sensors is responsive to changing the pitch angle of the rotor blade.

17. The method of claim 16, wherein the data input relates to pitch angle.

18. The method of claim 15, wherein the step of sending the command to the actuator is responsive to receiving the data input from the one or more sensors.

19. The method of claim 18, wherein the data input relates to a position of a collective pull lever.

20. The method of claim 15 further comprising collectively changing the pitch angle of all rotor blades attached to the rotorcraft.
